(19) United States
(12) Patent Application Publication
(10) Pub. No.: US 2008/0153664 A1
(43) Pub. Date: Jun. 26, 2008

(54) Control apparatus for vehicular drive system

(75) Inventors: Atsushi Tabata, Okazaki-shi (JP); Tooru Matsubara, Toyota-shi (JP); Hiroyuki Shibata, Susono-shi (JP); Kenta Kumazaki, Toyota-shi (JP)

Correspondence Address: OLIFF & BERRIDGE, PLC, P.O. BOX 320850, ALEXANDRIA, VA, 22320-4850, US

(73) Assignee: TOYOTA JIDOSHA KABUSHIKI KAISHA, TOYOTA-SHI (JP)

(21) Appl. No.: 11/905,470

(22) Filed: Oct. 1, 2007

(30) Foreign Application Priority Data
Oct. 31, 2006 (JP) 2006-297175
Oct. 31, 2006 (JP) 2006-297176

(51) Int. Cl. B60W 10/10

(52) U.S. Cl. 477/37; 701/51

(57) ABSTRACT

A control apparatus for a vehicular drive system including a first or continuously-variable transmission portion and a second or step-variable transmission portion which are disposed in series with each other, the first transmission portion being switchable between a continuously-variable shifting state and a step-variable shifting state, and the second transmission portion having a plurality of gear positions having respective speed ratios, the control apparatus including a step-variable shifting control portion configured to be operable upon concurrent occurrences of a shift-down action of one of the first and second transmission portions and a shift-up action of the other of the first and second transmission portions, to control the first transmission portion placed in the step-variable shifting state such that the shifting action of the first transmission portion is performed in synchronization with the shifting action of the second transmission portion, or operable upon concurrent occurrences of a switching action of the first transmission portion between the two shifting sates and a shifting action of the second transmission portion, to control the first transmission portion such that the switching action is performed during the shifting action of the second transmission portion.

The present application claims the benefits of Japanese Patent Application Nos. 2006-297175 and 2006-297176 both filed Oct. 31, 2006, the disclosure of which is herein incorporated by reference in its entirety.

### BACKGROUND OF THE INVENTION

1. Field of the Invention

The present invention relates in general to a control apparatus for a vehicular drive system including a first transmission portion (continuously-variable transmission portion) and a second transmission portion (step-variable transmission portion) disposed in series with each other, the first transmission portion being operable selectively as an electrically controlled continuously-variable transmission and a step-variable transmission, while the second transmission portion having a plurality of gear positions having respective speed ratios which change in steps. The continuously-variable transmission portion (first transmission portion) is switchable between a continuously-variable shifting state in which it is operable as the electrically controlled continuously-variable transmission and a step-variable shifting state in which it is operable as the step-variable transmission. More particularly, the invention relates to techniques for reducing a shifting shock of the vehicular drive system upon concurrent occurrences of shifting actions of the first and second transmission portions, or upon concurrent occurrences of a switching action of the continuously-variable transmission between the continuously-variable and step-variable shifting states, and a shifting action of the step-variable transmission portion (second transmission portion).

2. Discussion of Prior Art

There is known a drive system for a vehicle, which includes a first transmission portion or a continuously-variable transmission portion operable selectively as an electrically controlled continuously-variable transmission and a step-variable transmission, and a second transmission portion or a step-variable transmission portion which is disposed in series with the first transmission portion and which has a plurality of gear positions having respective speed ratios that change in steps. The continuously-variable transmission portion is switchable between a continuously-variable shifting state in which it is operable as the electrically controlled transmission, and a step-variable shifting state in which it is operable as the step-variable transmission. JP-2005-206136A discloses an example of such a drive system for a hybrid vehicle. This vehicular drive system is provided with a second electric motor disposed in a power transmitting path between drive wheels and a power transmitting member connecting the first and second transmission portions (continuously-variable and step-variable transmission portions), and the second transmission portion is constituted by a step-variable automatic transmission which is configured to change a speed of its input member in the form of the power transmitting member which receives a vehicle drive force from an engine, such that a ratio of the speed of the input member to a speed of an output member of the step-variable automatic transmission is variable in steps.

In the conventional vehicular drive system as disclosed in the above-identified publication, it is desirable that a power transmitting device as a whole is operable as a step-variable automatic transmission device having a relatively large number of gear positions having speed ratios which are relatively close to each other and which change over a relatively wide range.

### SUMMARY OF THE INVENTION

The present invention was made in view of the background art described above. It is therefore an object of this invention to provide a control apparatus for a vehicular drive system having a power transmitting device, which control apparatus can effectively reduce a shifting shock of the power transmitting device during its operation as a step-variable automatic transmission having a relatively large number of gear positions.

The object indicated above can be achieved according to a first aspect of this invention, which provides a control apparatus for a vehicular drive system including a first transmission portion and a second transmission portion which are disposed in series with each other, the first transmission portion being operable selectively as an electrically controlled continuously-variable transmission and a step-variable transmission, and the second transmission portion having a plurality of gear positions having respective speed ratios, the control apparatus comprising a step-variable shifting control portion operable upon concurrent occurrences of a shift-down action of one of the first and second transmission portions and a shift-up action of the other of the first and second transmission portions, the step-variable shifting control portion being configured to control the first transmission portion operating as the step-variable transmission, such that the shifting action of the first transmission portion is performed in synchronization with the shifting action of the second transmission portion.

In the vehicular drive system control apparatus according to the first aspect of this invention, the step-variable shifting control portion is provided to control the first transmission portion operating as the step-variable transmission, upon concurrent occurrences of the shift-down action and the shift-up action of one and the other of the first and second transmission portions, such that the shifting action of the first transmission portion is performed in synchronization with the shifting action of the second transmission portion. Accordingly, the shifting shock of the vehicular drive system can be effectively reduced, with the shift-down and shift-up actions of the two transmission portions being controlled in timed relation with each other. For instance, the first transmission portion operating as the step-variable transmission has two gear positions, and a power transmitting device consisting of the first and second transmission portions and operatively connected to an engine is arranged to perform a shifting action with a shift-down action of one of the first and second transmission portions and a shift-up action of the other transmission portion. During this shifting action of the power transmitting device, the shift-down and shift-up actions of the first and second transmission portions would cause the engine speed to change in the opposite directions, in the absence of the step-variable shifting control portion of the present control apparatus, so that the shift-down and shift-up actions of the two transmission portions require a complicated and precise control to suitably control the shifting action of the power transmitting device, giving rise to a risk of generation of a shifting shock of the power transmitting device due to an inadequate control of the shift-down and shift-up actions by the conventional control apparatus.

In a first preferred form of the first aspect of the invention, the step-variable shifting control portion controls the first transmission portion operating as the step-variable transmission such that the shifting action of the first transmission portion is initiated and terminated within an inertia phase of the shifting action of the second transmission portion. In this form of the invention, a change of the speed of the first transmission portion due to its shifting action is absorbed by a change of the speed of the second transmission portion due to its shifting action, so that the shifting shock of the vehicular drive system can be effectively reduced.

In one advantageous arrangement of the first preferred form of the invention, the vehicular drive system further includes an engine operatively connected to the first transmission portion, and the control apparatus further comprises engine output reducing means configured to temporarily reduce an output torque of the engine during the inertia phase of the shifting action of the second transmission portion. The arrangement permits reduction of a torque to be transmitted through the first and second transmission portions during their shifting actions, thereby reducing the shifting shock of the vehicular drive system.

In a second preferred form of the first aspect of this invention, the vehicular drive system further includes an engine operatively connected to the first transmission portion, and the control apparatus further comprises engine-speed control means for controlling the first transmission portion operating as the step-variable transmission and the second transmission portion such that an operating speed of the engine changes in only one direction during the shifting actions of the first and second transmission portions. In this form of the invention, the direction of change of the engine speed caused by the shifting action of the first transmission portion is the same as the direction of change of the engine speed caused by the shifting action of the second transmission portion, so that the vehicle operator feels comfortable with the shifting actions of the two transmission portions as if the vehicular drive system performs a single shifting action.

In one advantageous arrangement of the second preferred form of the invention, the first and second transmission portions are disposed in a power transmitting path between the engine and drive wheels of a vehicle for which the vehicular drive system is provided, and the first transmission portion includes a first electric motor, and a differential mechanism operable to distribute an output of the engine to the first electric motor and an input shaft of the second transmission portion, the engine-speed control means including first-motor-speed control means configured to control the first electric motor such that the operating speed of the engine changes in the above-indicated one direction during the shifting actions of the first and second transmission portions. This arrangement permits an easy control of the first electric motor such that the direction of change of the engine speed caused by the shifting action of the first transmission portion is the same as the direction of change of the engine speed caused by the shifting action of the second transmission portion.

Preferably, the first-motor-speed control means controls an operating speed of the first electric motor according to a change of a rotating speed of the input shaft of the second transmission portion during the shifting actions of the first and second transmission portions. Accordingly, the engine speed is controlled by controlling the operating speed of the first electric motor according to the change of the input speed of the second transmission portion which is initiated upon initiation of the shifting action of the second transmission portion. Thus, the engine speed changes according to a progress of the shifting action of the second transmission portion.

Preferably, the differential mechanism in the above-described advantageous arrangement of the second preferred form of the invention includes a planetary gear set having three rotary elements that are rotatable relative to each other, and the first transmission portion includes coupling devices operable to selectively fix one of the three rotary elements to a stationary member and to selectively two of the three rotary elements to each other.

In a third preferred form of the first aspect of this invention, the second transmission portion includes a plurality of coupling devices, and the shifting action of the second transmission portion is effected by a releasing action of one of the plurality of coupling devices and an engaging action of another of the plurality of coupling devices, which releasing and engaging actions take place substantially concurrently. Generally, it is difficult to control the timings of these concurrent releasing and engaging actions of the two coupling devices for performing the shifting action of the second transmission portion without a considerably shifting shock. However, the step-variable shifting control portion of the present control apparatus is arranged to control the first transmission portion such that the shifting action of the first transmission portion is performed in synchronization with the shifting action of the second transmission portion, so as to reduce the shifting shock due to an inadequate timing control of the concurrent releasing and engaging actions of the coupling devices.

In a fourth preferred form of the first aspect of the invention, the vehicular drive system includes an engine operatively connected to the first transmission portion, and the first transmission portion is a continuously-variable transmission portion which is operable as an electrically controlled continuously-variable transmission and which includes a differential mechanism operable to distribute an output of the engine to a first electric motor and a power transmitting member, and a second electric motor disposed in a power transmitting path between the power transmitting member and drive wheels of a vehicle for which the vehicular drive system is provided.

In a fifth preferred form of the first aspect of the invention, the vehicular drive system includes an engine operatively connected to the first transmission portion, and the first transmission portion is a differential portion including a differential mechanism operable to distribute an output of the engine to a first electric motor and a power transmitting member, and a second electric motor disposed in a power transmitting path between the power transmitting member and drive wheels of a vehicle for which the vehicular drive system is provided.

The differential mechanism of the first transmission portion provided in the above-described advantageous arrangement of the second preferred form of the invention includes a planetary gear set having three rotary elements consisting of a first rotary element connected to the engine, a second rotary element connected to the first electric motor and a third rotary element connected to the power transmitting member and a second electric motor.

The differential mechanism may include two planetary gear sets. The first electric motor or the second electric motor may be provided in the differential mechanism or the power transmitting path, via a speed reduction device.

The differential mechanism preferably includes frictional coupling devices operable to place the differential mechanism in a selected one of a differential state and a non-differential state. In this case, the first transmission portion is switchable between a non-locked or continuously-variable shifting state in which a differential function of the first transmission portion is limited, and a locked or step-variable shifting state in which the first transmission portion has a selected fixed speed ratio. Preferably, those frictional coupling devices are operable to connect selected two of rotary elements of the differential mechanism to each other for rotating the two rotary elements as a unit to give the first transmission portion a speed ratio of 1, and fix a selected one of said rotary elements to a stationary member (12; 91) for enabling the first transmission portion to operate as a speed-increasing device having a speed ratio smaller than 1.

In a sixth preferred form of the first aspect of this invention, the step-variable shifting control portion includes concurrent shifting determining means for determining whether the shift-down and shift-up actions of one and the other of the first and second transmission portions should occur concurrently, second-shifting-action control means for initialing the shifting action of the second transmission portion when the concurrent shifting determining means has determined that the shift-down and shift-up actions should occur concurrently, inertia-phase determining means for determining whether the shifting action of the second transmission portion is in an inertia phase, and first-shifting-action control means for controlling the first transmission portion such that the shifting action of the first transmission portion is initiated and terminated within the inertia phase of the shifting action of the second transmission portion determined by the inertia-phase determining means.

In one advantageous arrangement of the above-described sixth preferred form, the first-shifting-action control means controls the first transmission portion operating as the step-variable transmission, in synchronization of a shifting action of the second transmission portion from one of the plurality of gear positions to another of the gear positions.

In another advantageous arrangement of the above-described sixth preferred form, the second-shifting-action control means controls the second transmission portion to perform the shifting action while a running condition of a vehicle for which the vehicular drive system is provided is in one of a high-torque running region, a high-output running region and a high-speed running region.

In a seventh preferred form of the first aspect of the invention, the first transmission portion includes a transmission mechanism a speed ratio of which is variable continuously or in steps.

The object indicated above can also be achieved according a second aspect of this invention, which provides a control apparatus for a vehicular drive system including a continuously-variable transmission portion and a step-variable transmission portion which are disposed in series with each other, the step-variable transmission portion having a plurality of gear positions having respective speed ratios, and the continuously-variable transmission portion being switchable between a continuously-variable shifting state in which the continuously-variable transmission portion is operable as an electrically controlled continuously-variable transmission, and a step-variable shifting state in which the continuously-variable transmission portion is not operable as the electrically controlled continuously variable transmission, said control apparatus comprising a step-variable shifting control portion operable upon concurrent occurrences of a switching action of the continuously-variable transmission portion between the continuously-variable and step-variable shifting states and a shifting action of the step-variable transmission portion, the step-variable shifting control portion being configured to control the continuously-variable transmission portion such that the switching action of the continuously-variable transmission portion is performed during the shifting action of the step-variable transmission portion.

In the vehicular drive system control apparatus according to the second aspect of this invention, the step-variable shifting control portion is provided to control the continuously-variable transmission portion, upon concurrent occurrences of the switching action of the continuously-variable transmission portion between the continuously-variable and step-variable shifting states and the shifting action of the step-variable transmission portion, such that the switching action of the continuously-variable transmission portion is performed during the shifting action of the step-variable transmission portion. Namely, the shifting state of the continuously-variable transmission portion is changed during the shifting action of the step-variable transmission portion from one of the plurality of gear positions to another of the gear positions. It is generally desirable to increase the number of the gear positions of the step-variable transmission portion. Where the step-variable transmission portion has a relatively large number of gear positions, the step-variable transmission portion may be shifted from one gear position to another gear position when the continuously-variable transmission portion is switched between the continuously-variable and step-variable shifting states. These concurrent switching and shifting actions of the continuously-variable and step-variable transmission portions require a complicated and precise control to suitably control the switching and shifting actions, giving rise to a risk of generation of a shifting shock of the vehicular drive system due to an inadequate control of the switching and shifting actions by the conventional control apparatus.

In a first preferred form of the second aspect of this invention, the step-variable shifting control portion controls the continuously-variable transmission portion such that the switching action of the continuously-variable transmission portion is initiated and terminated within an inertia phase of the shifting action of the step-variable transmission portion. In this form of the invention, a change of the speed of the continuously-variable transmission portion due to its switching action is absorbed by a change of the speed of the step-variable transmission portion due to its shifting action, so that the shifting shock of the vehicular drive system can be effectively reduced.

In an advantageous arrangement of the first preferred form of the second aspect of the invention, the vehicular drive system further includes an engine operatively connected to the continuously-variable transmission portion, and the continuously-variable and step-variable transmission portions are disposed in a power transmitting path between the engine and drive wheels of a vehicle for which the vehicular drive system is provided, the control apparatus further comprising engine-speed control means for controlling the continuously-variable and step-variable transmission portions such that an operating speed of the engine changes in only one direction during the shifting action of the step-variable transmission portion. In this arrangement, the direction of change of the engine speed caused by the switching action of the continuously-variable transmission portion is the same as the direction of change of the engine speed caused by the shifting action of the step-variable transmission portion, so that the vehicle operator feels comfortable with the switching and shifting actions of the two transmission portions as if the vehicular drive system performs a single shifting action.

Preferably, the continuously-variable transmission portion includes a first electric motor, and a differential mechanism operable to distribute an output of the engine to the first electric motor and an input shaft of the step-variable transmission portion. In this case, the first-motor-speed control means controls an operating speed of the first electric motor according to a change of a rotating speed of the input shaft of the second transmission portion. Accordingly, the engine speed can be easily controlled by controlling the operating speed of the first electric motor according to a progress of the shifting action of the step-variable transmission portion, such that the direction of change of the engine speed caused by the switching action of the continuously-variable transmission portion is the same as the direction of change of the engine speed caused by the shifting action of the step-variable transmission portion.

Preferably, the above-described differential mechanism includes a planetary gear set having a plurality of rotary elements, and the first transmission portion includes a plurality of coupling devices operable to selectively fix one of the rotary elements to a stationary member and to selectively connected two of the rotary elements to each other. In this case, the continuously-variable transmission portion is switchable between the continuously-variable and step-variable shifting states by selective engaging and releasing actions of the plurality of coupling devices. The continuously-variable transmission portion preferably further includes a second electric motor disposed in the power transmitting path between the differential mechanism and the vehicle drive wheels.

In a second preferred form of the second aspect of the invention, the vehicular drive system further includes an engine operatively connected to the continuously-variable transmission portion, and the control apparatus further comprises engine output reducing means for temporarily reducing an output torque of the engine in a terminal portion of a shift-down action of the step-variable transmission portion which occurs concurrently with the switching action of the continuously-variable transmission portion. Accordingly, the torque to be transmitted through the step-variable transmission portion in the terminal portion of the shift-down action is reduced, so that a speed synchronizing shock at the end of the shift-down action is reduced.

In a third preferred form of the second aspect of the invention, the step-variable transmission portion includes a plurality of coupling devices, and the shifting action of the step-variable transmission portion is effected by a releasing action of one of the plurality of coupling devices and an engaging action of another of the plurality of coupling devices, which releasing and engaging actions take place substantially concurrently. In this case wherein the switching action of the continuously-variable transmission is performed during the concurrent releasing and engaging actions of the two coupling devices, the switching shock of the continuously-variable transmission can be effectively reduced.

Preferably, the above-indicated differential mechanism includes a planetary gear set having three rotary elements consisting of a first rotary element connected to the engine, a second rotary element connected to the first electric motor and a third rotary element connected to the input shaft and a second electric motor.

The differential mechanism of the continuously-variable transmission portion may include two planetary gear sets. The first electric motor or the second electric motor may be provided in the differential mechanism or the power transmitting path, via a speed reduction device.

The differential mechanism of the continuously-variable transmission portion preferably includes frictional coupling devices operable to place the differential mechanism in a selected one of a differential state and a non-differential state. In this case, the continuously-variable transmission portion is switchable between a non-locked or continuously-variable shifting state in which a differential function of the continuously-variable transmission portion is limited, and a locked or step-variable shifting state in which the continuously-variable transmission portion has a selected fixed speed ratio. Preferably, those frictional coupling devices include a switching clutch operable to connect selected two of rotary elements of the differential mechanism to each other for rotating the two rotary elements as a unit to give the continuously-variable transmission portion a speed ratio of 1, and fix a selected one of said rotary elements to a stationary member for enabling the continuously-variable transmission portion to operate as a speed-increasing device having a speed ratio smaller than 1.

In a fourth preferred form of the second aspect of this invention, the vehicular drive system includes an engine operatively connected to the continuously-variable transmission portion, and the continuously-variable transmission portion includes a first electric motor, the step-variable shifting control means includes concurrent switching/shifting determining means for determining whether the switching action of the continuously-variable transmission portion and the shifting action of the step-variable transmission portion should occur concurrently, step-variable-transmission-portion control portion for initiating the shifting action of the step-variable transmission portion when the concurrent switch/shifting determining means has determined that the switching action and the shifting action should occur concurrently, continuously-variable-transmission-portion control means for controlling the switching action of the continuously-variable transmission portion such that the switching action is performed during the shifting action of the step-variable transmission portion, and switching completion determining means for determining whether the switching action is completed, the control device further comprising first-motor-speed control means for controlling an operating speed of the first electric motor such that an operating speed of the engine changes in only one direction during the shifting action of the step-variable transmission portion, and engine output reducing means for temporarily reducing an output torque of the engine after the switching completion determining means has determined that the switching is completed, the step-variable-transmission-portion control means terminating the shifting action of the step-variable transmission portion when the switching completion determining means has determined that the switching is completed.

In one advantageous arrangement of the fourth preferred form of the second aspect of the invention, the step-variable-transmission-portion control means controls the step-variable transmission portion to perform the shifting action while a running condition of a vehicle for which the vehicular drive system is provided is in one of a high-torque running region, a high-output running region and a high-speed running region.

In second advantageous arrangement of the above-indicated fourth preferred form, the first-motor-speed control means reduces the operating speed of the first electric motor such the operating speed of the engine continuously decreases during a shift-down action of the step-variable transmission portion which occurs concurrently with the switching action of the continuously-variable transmission portion.

The object indicated above can also be achieved according to a third aspect of this invention, which provides a control apparatus for a vehicular drive system including a differential portion and a step-variable transmission portion which are disposed in series with each other, the step-variable transmission portion having a plurality of gear positions having respective speed ratios, and the differential portion having a differential portion and being switchable between a differential state in which the differential mechanism is operable to perform a differential function, and a non-differential state in which the differential mechanism is not operable to perform the differential function, said control apparatus comprising a step-variable shifting control portion operable upon concurrent occurrences of a switching action of the differential portion between the differential and non-differential states and a shifting action of the step-variable transmission portion, the step-variable shifting control portion being configured to control the differential portion such that the switching action of the differential portion is performed during the shifting action of the step-variable transmission portion.

In the vehicular drive system control apparatus according to the third aspect of this invention, the step-variable shifting control portion is provided to control the differential portion, upon concurrent occurrences of the switching action of the differential portion between the differential and non-differential states and the shifting action of the step-variable transmission portion, such that the switching action of the differential portion is performed during the shifting action of the step-variable transmission portion. Namely, the differential transmission portion is switched between the differential and non-differential states during the shifting action of the step-variable transmission portion from one of the plurality of gear positions to another of the gear positions. It is generally desirable to increase the number of the gear positions of the step-variable transmission portion. Where the step-variable transmission portion has a relatively large number of gear positions, the step-variable transmission portion may be shifted from one gear position to another gear position when the differential portion is switched between the differential and non-differential states. These concurrent switching and shifting actions of the differential portion and the step-variable transmission portion require a complicated and precise control to suitably control the switching and shifting actions, giving rise to a risk of generation of a shifting shock of the vehicular drive system due to an inadequate control of the switching and shifting actions by the conventional control apparatus.

The preferred forms and advantageous arrangements described above in the paragraphs [0025] through [0036] with respect to the second aspect of the invention are applicable to the third aspect of the invention described above in the paragraphs [0037] and [0038]. For the third aspect of the invention, the “continuously-variable transmission portion”, “continuously-variable shifting state” and “step-variable shifting state” appearing in the paragraphs [0025]-[0036] should read “differential portion”, “differential state” and “non-differential state”, respectively.

### BRIEF DESCRIPTION OF THE DRAWINGS

FIG. 1 is a schematic view showing an arrangement of a transmission mechanism of a drive system of a hybrid vehicle to which the present invention is applicable;

FIG. 2 is a table indicating shifting actions of the transmission mechanism of FIG. 1 placed in a step-variable shifting state, in relation to different combinations of operating states of hydraulically operated frictional coupling devices to effect the respective shifting actions;

FIG. 3 is a collinear chart indicating relative rotating speeds of the transmission mechanism of FIG. 1 placed in the step-variable shifting state, in different gear positions of the transmission mechanism;

FIG. 4 is a view indicating input and output signals of a control apparatus in the form of an electronic control device constructed according to a first embodiment of this invention to control the drive system of FIG. 1;

FIG. 5 is a functional block diagram illustrating major control functions of the electronic control device of FIG. 4;

FIG. 6 is a view illustrating an example of a stored shifting boundary line map used for determining a shifting action of an automatic transmission portion, an example of a stored shifting-state switching boundary line map used for switching the shifting state of the transmission mechanism, and an example of a stored drive-power-source switching boundary line map defining boundary lines between an engine drive region and a motor drive region for switching between an engine drive mode and a motor drive mode, in the same two-dimensional coordinate system defined by control parameters in the form of a running speed and an output torque of the vehicle, such that those maps are related to each other;

FIG. 7 is a view showing an example of a manually operated shifting device including a shift lever and operable to select one of a plurality of shift positions;

FIG. 8 is a flow chart illustrating a concurrent shifting control routine executed by the electronic control device of FIG. 4;

FIG. 9 is a time chart for explaining changes of various parameters according to the concurrent shifting control routine of FIG. 8;

FIG. 10 is a block diagram corresponding to that of FIG. 5, showing an electronic control device constructed according to second embodiment of this invention;

FIG. 11 is a view corresponding to that of FIG. 6, for explaining the second embodiment;

FIG. 12 is a flow chart illustrating a concurrent switching/shifting control routine executed by the electronic control device of FIG. 10;

FIG. 13 is a time chart for explaining changes of various parameters according to the concurrent switching/shifting control routine of FIG. 12;

FIG. 14 is a schematic view showing an arrangement of a transmission mechanism which is controllable by the electronic control device of the first embodiment of FIG. 5 or second embodiment of FIG. 10 according to a third embodiment of this invention;

FIG. 15 is a table indicating shifting actions of the transmission mechanism of FIG. 14 placed in the step-variable shifting state, in relation to different combinations of operating states of hydraulically operated frictional coupling devices to effect the respective shifting actions; and

FIG. 16 is a collinear chart indicating relative rotating speeds of the transmission mechanism of FIG. 14 placed in the step-variable shifting state, in different gear positions of the transmission mechanism.

### DETAILED DESCRIPTION OF PREFERRED EMBODIMENTS

### First Embodiment

The embodiments of this invention will be described in detail by reference to the drawings.

### Embodiment 1

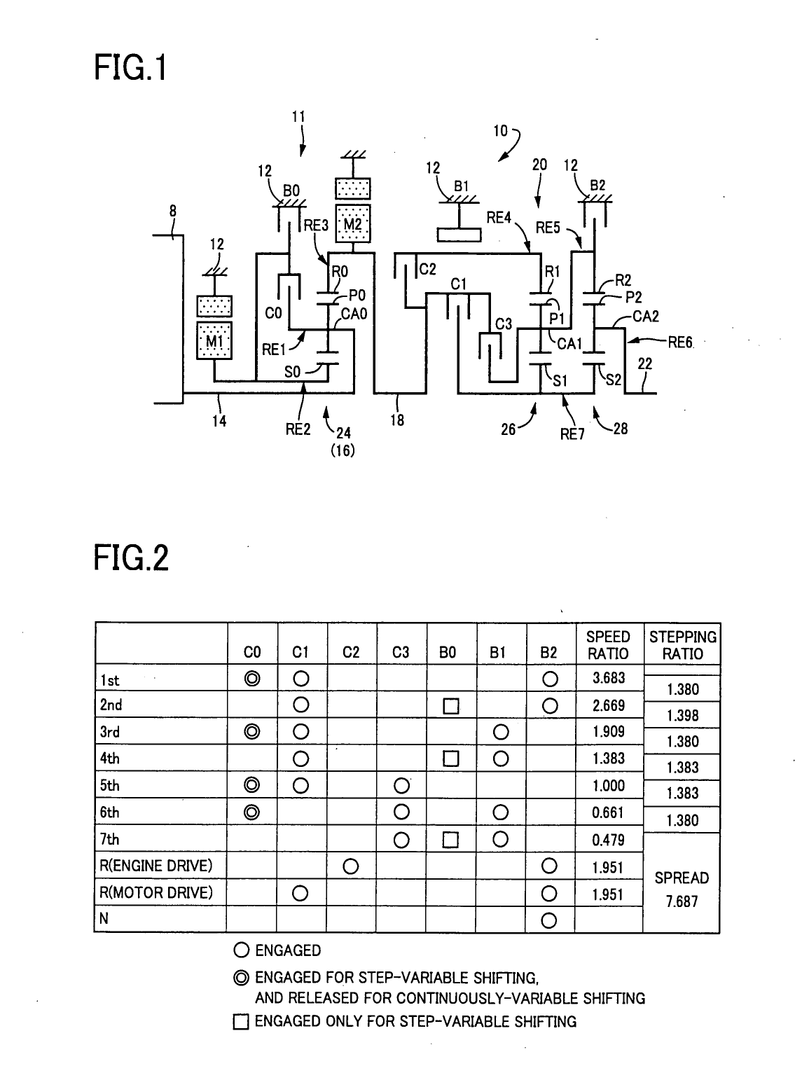

Referring first to the schematic view of FIG. 1, there is shown a transmission mechanism (power transmitting device) 10 constituting a part of a drive system for a hybrid vehicle, which drive system is controlled by a control apparatus according to a first embodiment of this invention. As shown in FIG. 1, the transmission mechanism 10 includes: an input rotary member in the form of an input shaft 14 connected directly or indirectly via a pulsation absorbing damper or vibration damping device (not shown) to an engine 8; a first transmission portion or a continuously-variable transmission portion in the form of a differential portion 11 connected to the input shaft 14; a second transmission portion or step-variable or multiple-step transmission portion in the form of an automatic transmission portion 20 disposed in a power transmitting path between the differential portion 11 and drive wheels 38 of the vehicle, and connected in series via a power transmitting member (power transmitting shaft) 18 to the differential portion 11 and the drive wheels 38; and an output rotary member in the form of an output shaft 22 connected to the automatic transmission portion 20. The input shaft 12, differential portion 11, automatic transmission portion 20 and output shaft 22 are coaxially disposed on a common axis in a transmission casing 12 (hereinafter referred to as casing 12) functioning as a stationary member attached to a body of the vehicle, and are connected in series with each other. This transmission mechanism 10 is suitably used for a transverse FR vehicle (front-engine, rear-drive vehicle), and is disposed between a drive power source in the form of the engine 8 and the pair of drive wheels 38, to transmit a vehicle drive force from the engine 8 to the pair of drive wheels 38 through a differential gear device 36 (final speed reduction gear device) and a pair of drive axles, as shown in FIG. 5. The engine 8 may be an internal or external combustion engine such as a gasoline engine or diesel engine, which functions as one of vehicle drive power sources.

In the present transmission mechanism 10, the engine 8 and the differential portion 11 are directly connected to each other. This direct connection means that the engine 8 and the transmission portion 11 are connected to each other, without a fluid-operated power transmitting device such as a torque converter or a fluid coupling being disposed therebetween, but may be connected to each other through a pulsation absorbing damper as described above. It is noted that a lower half of the transmission mechanism 10, which is constructed symmetrically with respect to its axis, is omitted in FIG. 1.

The differential portion 11 is provided with: a first electric motor M1; a power distributing mechanism 16 functioning as a differential mechanism operable to mechanically distribute an output of the engine 8 received by the input shaft 14, to the first electric motor M1 and the power transmitting member 18; and a second electric motor M2 which is rotated with the power transmitting member 18. The second electric motor M2 may be disposed at any portion of the power transmitting path between the power transmitting member 18 and the drive wheels 38. Each of the first and second electric motors M1 and M2 used in the present embodiment is a so-called motor/generator having a function of an electric motor and a function of an electric generator. However, the first electric motor M1 should function at least as an electric generator operable to generate an electric energy and a reaction force, while the second electric motor M2 should function at least as a drive power source operable to produce a vehicle drive force.

The power distributing mechanism 16 includes, as major components, a planetary gear set 24 of a single pinion type having a gear ratio ρ1 of about 0.380, for example, a switching clutch C0 and a switching brake B0. The planetary gear set 24 has rotary elements consisting of a sun gear S0, a planetary gear P0; a carrier CA0 supporting the planetary gear P0 such that the planetary gear P0 is rotatable about its axis and about the axis of the sun gear S0; and a ring gear R1 meshing with the sun gear S0 through the planetary gear P0. Where the numbers of teeth of the sun gear S0 and the ring gear R0 are represented by ZS0 and ZR0, respectively, the above-indicated gear ratio ρ1 is represented by ZS0/ZR0.

In the power distributing mechanism 16, the carrier CA0 is connected to the input shaft 14, that is, to the engine 8, and the sun gear S0 is connected to the first electric motor M1, while the ring gear R0 is connected to the power transmitting member 18. The switching brake B0 is disposed between the sun gear S0 and the casing 12, and the switching clutch C0 is disposed between the sun gear S0 and the carrier CA0. When the switching clutch C0 and brake B0 are both released, the power distributing mechanism 16 is placed in a differential state in which three elements of the planetary gear set 24 consisting of the sun gear S0, carrier CA0 and ring gear R0 are rotatable relative to each other, so as to perform a differential function, so that the output of the engine 8 is distributed to the first electric motor M1 and the power transmitting member 18, whereby a portion of the output of the engine 8 is used to drive the first electric motor M1 to generate an electric energy which is stored or used to drive the second electric motor M2. Accordingly, the differential portion 11 (power distributing mechanism 16) is placed in a continuously-variable shifting state (electrically established CVT state), in which the rotating speed of the power transmitting member 18 is continuously variable, irrespective of the rotating speed of the engine 8, namely, placed in a differential state in which a speed ratio γ0 (rotating speed of the input shaft 14/rotating speed of the power transmitting member 18) of the power distributing mechanism 16 is continuously changed from a minimum value γ0min to a maximum value γ0max. That is, the differential portion 11 is placed in the continuously-variable shifting state in which the power distributing mechanism 16 functions as an electrically controlled continuously-variable transmission the speed ratio γ0 of which is continuously variable from the minimum value γ0min to the maximum value γ0max.

When the switching clutch C0 or brake B0 is engaged while the power distributing mechanism 16 is placed in the continuously-variable shifting state, the power distributing mechanism 16 is brought into a non-differential state in which the differential function is not available. Described in detail, when the switching clutch C0 is engaged, the sun gear S0 and the carrier CA0 are connected together, so that the power distributing mechanism 16 is placed in a locked state in which the three rotary elements of the planetary gear set 24 consisting of the sun gear S0, carrier CA0 and ring gear R0 are rotatable as a unit, namely, placed in a first non-differential state in which the differential function is not available, so that the differential portion 11 is also placed in a non-differential state. In this non-differential state, the rotating speed of the engine 8 and the rotating speed of the power transmitting member 18 are made equal to each other, so that the differential portion 11 (power distributing mechanism 16) is placed in a fixed-speed-ratio shifting state or step-variable shifting state in which the power distributing mechanism 16 functions as a transmission having a fixed speed ratio γ0 equal to 1.

When the switching brake B0 is engaged in place of the switching clutch C0, the sun gear S0 is fixed to the casing 12, so that the power distributing mechanism 16 is placed in the non-differential state in which the sun gear S0 is not rotatable, namely, placed in a second non-differential state in which the differential function is not available, so that the differential portion 11 is also placed in a non-differential state. Since the rotating speed of the ring gear R0 is made higher than that of the carrier CA0, the differential portion 11 is placed in the fixed-speed-ratio shifting state or step-variable shifting state in which differential portion 11 (the power distributing mechanism 16) functions as a speed-increasing transmission having a fixed speed ratio γ0 smaller than 1, for example, about 0.7.

Thus, the frictional coupling devices in the form of the switching clutch C0 and brake B0 function as a differential-state switching device operable to selectively switch the differential portion 11 (power distributing mechanism 16) between the differential state (namely, non-locked state) and the non-differential state (namely, locked state), that is, between the continuously-variable shifting state in which the differential portion 11 (the power distributing mechanism 16) is operable as an electrically controlled continuously-variable transmission the speed ratio of which is continuously variable, and the step-variable shifting state or locked state in which the differential portion 11 is operable as the step-variable transmission and in which the speed ratio of the transmission portion 11 is held fixed, namely, in the fixed-speed-ratio shifting state (non-differential state) in which the transmission portion 11 is operable as a transmission having a single gear position with one speed ratio or a plurality of gear positions with respective speed ratios.

In other words, the switching clutch C0 and switching brake B0 function as a differential limiting device operable to limit the differential function of the power distributing mechanism 16 for limiting the electric differential function of the differential portion 11, namely, the function of the differential portion 11 as the electrically controlled continuously-variable transmission, by placing the power distributing mechanism 16 in its non-differential state to place the differential portion 11 in its step-variable shifting state.

The automatic transmission portion 20 includes a single-pinion type first planetary gear set 26 and a single-pinion type second planetary gear set 28, and functions as a step variable automatic transmission having four gear positions. The first planetary gear set 26 has: a first sun gear S1; a first planetary gear P1; a first carrier CA1 supporting the first planetary gear P1 such that the first planetary gear P1 is rotatable about its axis and about the axis of the first sun gear S1; and a first ring gear R1 meshing with the first sun gear S1 through the first planetary gear P1. For example, the first planetary gear set 26 has a gear ratio ρ1 of about 0.529. The second planetary gear set 28 has: a second sun gear S2; a second planetary gear P2; a second carrier CA2 supporting the second planetary gear P2 such that the second planetary gear P2 is rotatable about its axis and about the axis of the second sun gear S2; and a second ring gear R2 meshing with the second sun gear S2 through the second planetary gear P2. For example, the second planetary gear set 28 has a gear ratio ρ2 of about 0.372. Where the numbers of teeth of the first sun gear S1, first ring gear R1, second sun gear S2 and second ring gear R2 are represented by ZS1, ZR1, ZS2 and ZR2, respectively, the above-indicated gear ratios ρ1 and ρ2 are represented by ZS1/ZR1 and ZS2/ZR2, respectively.

In the automatic transmission portion 20, the first sun gear S1 and the second sun gear S2 are integrally fixed to each other as a unit, and selectively connected to the power transmitting member 18 through a first clutch C1. The first carrier CA1 and the second ring gear R2 are integrally fixed to each other as a unit, selectively fixed to the casing 12 through a second brake B2, and selectively connected to the power transmitting member 18 through a third clutch C3. The first ring gear R1 is selectively fixed to the casing 12 through a first brake B1, and selectively connected to the power transmitting member 18 through a second clutch C2. The second carrier CA2 is fixed to the output shaft 22. Thus, the automatic transmission portion 20 and the power transmitting member 18 are selectively connected to each other through the first clutch C1, second clutch C2 and third clutch C3, which are provided to shift the automatic transmission portion 20. In other words, the first clutch C1, second clutch C2 and third clutch C3 function as input clutches of the automatic transmission portion 20, and also function as a coupling device operable to place a power transmitting path between the power transmitting member 18 and the automatic transmission portion 20, that is, between the differential portion 11 (power transmitting member 18) and the drive wheels 38, selectively in one of a power transmitting state in which a vehicle drive force can be transmitted through the power transmitting path, and a power cut-off state in which the vehicle drive force cannot be transmitted through the power transmitting path. Described more specifically, the above-indicated power transmitting path is placed in the power transmitting state when at least one of the first, second and third clutches C1, C2, C3 is placed in the engaged state, and is placed in the power cut-off state when the first, second and third clutches C1, C2, C are placed in the released state.

The above-described switching clutch C0, first clutch C1, second clutch C2, third clutch C3, switching brake B0, first brake B1 and second brake B2 (hereinafter collectively referred to as clutches C and brakes B, unless otherwise specified) are hydraulically operated frictional coupling devices used in a conventional vehicular automatic transmission. Each of these frictional coupling devices is constituted by a wet-type multiple-disc clutch including a plurality of friction plates which are forced against each other by a hydraulic actuator, or a band brake including a rotary drum and one band or two bands which is/are wound on the outer circumferential surface of the rotary drum and tightened at one end by a hydraulic actuator. Each of the clutches C0-C3 and brakes B0-B2 is selectively engaged for connecting two members between which each clutch or brake is interposed.

In the transmission mechanism 10 constructed as described above, the power distributing mechanism 16 is provided with the switching clutch C0 and the switching brake B0 one of which is engaged to place the differential portion 11 in the step-variable shifting state (fixed-speed-ratio shifting state), and none of which is engaged to place the differential portion 11 in the continuously-variable shifting state. The differential portion 11 placed in the step-variable shifting state and the automatic transmission portion 20 constitute a step-variable transmission, while the differential portion 11 placed in the continuously-variable shifting state and the automatic transmission portion 20 function as an electrically controlled continuously-variable transmission.

When the transmission mechanism 10 functions as the step-variable transmission with the differential portion 11 placed in its step-variable shifting state with one of the switching clutch C0 and switching brake B0 held in the engaged state, one of a first gear position (first speed position) through a seventh gear position (seventh speed position), a reverse gear position (rear drive position) and a neural position is selectively established by engaging actions of a corresponding combination of the two frictional coupling devices selected from the above-described first clutch C1, second clutch C2, third clutch C3, first brake B1 and second brake B2, as indicated in the table of FIG. 2. The seven gear positions are forward drive positions. The above-indicated gear positions have respective speed ratios γT (speed N_{IN} of the input shaft 14/speed N_{OUT} of the output shaft 22) which change as geometric series and which provide a wide spread of 7.687, which is a ratio of a speed ratio γT1 of the first gear position to a speed ratio γT7 of the seventh gear position. The speed ratios γT are overall speed ratios of the transmission mechanism 10 determined by a speed ratio γ0 of the differential portion 11 and a speed ratio γA of the automatic transmission portion 20.

When the differential portion 11 functions as the step-variable transmission, the first gear position having the highest speed ratio γT1 of about 3.683, for example, is established by engaging actions of the switching clutch C0, first clutch C1 and second brake B2, and the second gear position having the speed ratio γT2 of about 2.669, for example, which is lower than the speed ratio γT1, is established by engaging actions of the switching clutch B0, first clutch C1 and second brake B2, as indicated in FIG. 2. Further, the third gear position having the speed ratio γT3 of about 1.909, for example, which is lower than the speed ratio γT2, is established by engaging actions of the switching clutch C0, first clutch C1 and first brake B1, and the fourth gear position having the speed ratio γT4 of about 1.383, for example, which is lower than the speed ratio γT3, is established by engaging actions of the switching brake B0, first clutch C1 and first brake B1. The fifth gear position having the speed ratio γ5 of about 1.000, for example, which is smaller than the speed ratio γT4, is established by engaging actions of the switching clutch C0, first clutch C1 and third clutch C3. Further, the sixth gear position having the speed ratio γT6 of about 0.661, for example, which is smaller than the speed ratio γT5, is established by engaging actions of the switching clutch C0, third clutch C3 and first brake B1, and the seventh gear position having the speed ratio γT7 of about 0.479, for example, which is smaller than the speed ratio γT6, is established by engaging actions of the switching brake B0, third clutch C3 and first brake B1. The reverse gear position having the speed ratio γR of about 1.951, for example, which is intermediate between the speed ratios γT2 and γT3, is established by engaging actions of the second clutch C2 and the second brake B2 when the reverse drive of the vehicle is effected by using the engine 8 as the drive-power source, and by engaging actions of the first clutch C1 and the second brake B2 when the reverse drive is effected by using the second electric motor M2 as the drive power source. The reverse drive position is usually established while the differential portion 11 is placed in the continuously-variable shifting state. The neutral position N is established by engaging only the second brake B2.

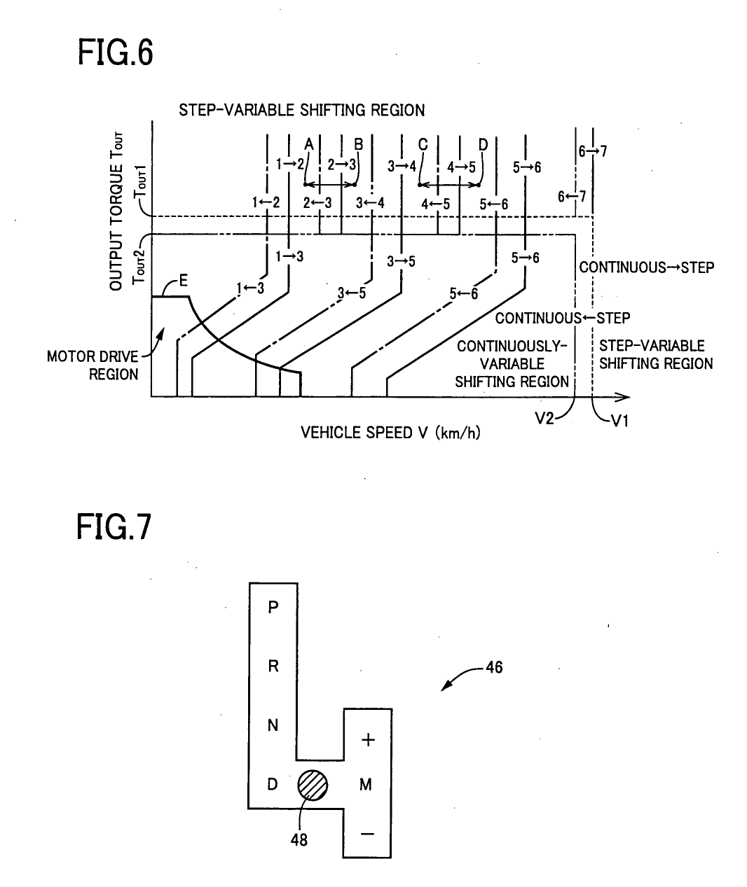

It will be understood from the foregoing description and FIG. 2 that the present transmission mechanism 10 is arranged to establish a selected one of the seven forward drive gear positions, by a corresponding one of combinations of a “clutch-to-clutch” shifting action of the differential portion 11 to select one of two speed positions by releasing one of the switching clutch C0 and switching brake B0 while at the same time engaging the other of these switching clutch C0 and brake B0, and a “clutch-to-clutch” shifting action of the automatic transmission portion 20 to select one of four speed positions by releasing one of the first clutch C1, second clutch C2, third clutch C3, first brake B1 and second brake B2 while at the same time engaging another of those clutches and brakes C1, C2, C3, B1, B2. Described in detail, the transmission mechanism 10 is shifted between the first and second gear positions, between the second and third gear positions, between the third and fourth gear positions, between the fourth and fifth gear positions, and between the sixth and seventh gear positions, by the first shifting action of the first transmission portion in the form of the differential portion 11 and the second shifting action of the second transmission portion in the form of the automatic transmission portion 20, which shifting actions occur or take place substantially concurrently. Further, the transmission mechanism 10 is shifted between the fifth and sixth gear positions, by the second shifting action of the second transmission portion. For example, a shifting action of the transmission mechanism 10 between the second and third gear positions as a result of a change of the vehicle condition between points A and B indicated in FIG. 6, and a shifting action of the transmission mechanism 10 between the fourth and fifth gear positions as a result of a change of the vehicle condition between points C and D indicated in FIG. 6 are effected by a shift-down action of one of the differential portion 11 and the automatic transmission portion 20, and a shift-up action of the other of the differential and automatic transmission portions 11, 20, which shift-down and shift-up actions occur concurrently. These concurrent shift-down and shift-up actions cause a shifting shock of the transmission mechanism 10. Namely, the shift-down action causes an increase of the engine speed N_{E}, while the shift-up action causes a decrease of the engine speed N_{E}. Accordingly, the engine speed N_{E} tends to fluctuate due to even a slight difference in timing of the shift-down and shift-up actions, leading to the shifting shock of the transmission mechanism 10, which is felt uncomfortable by the occupants of the vehicle.

Where the transmission mechanism 10 functions as the continuously-variable transmission with the differential portion 11 placed in its continuously-variable shifting state, on the other hand, the switching clutch C0 and the switching brake B0 indicated in FIG. 2 are both released, so that the differential portion 11 functions as the continuously variable transmission, while the automatic transmission portion 20 connected in series to the differential portion 11 functions as the step-variable transmission having the four forward drive gear positions, whereby the speed of the rotary motion transmitted to the automatic transmission portion 20 automatically shifted to a selected one of the four forward drive gear positions, namely, the rotating speed of the power transmitting member 18 is continuously changed, so that the speed ratio of the drive system when the automatic transmission portion 20 is placed in the selected gear position M is continuously variable over a predetermined range. Accordingly, the overall speed ratio γT of the transmission mechanism 10 is continuously variable, even while the speed ratio γA of the automatic transmission portion 20 is changed in steps.

Namely, when the transmission mechanism 10 functions as the continuously-variable transmission, with the switching clutch C0 and switching brake B0 being both placed in the released state, the speed ratio γ0 of the differential portion 11 is controlled so that the overall speed ratio γT of the transmission mechanism 10 is continuously variable across the adjacent ones of the first, second, third and fourth gear positions of the automatic transmission 20.

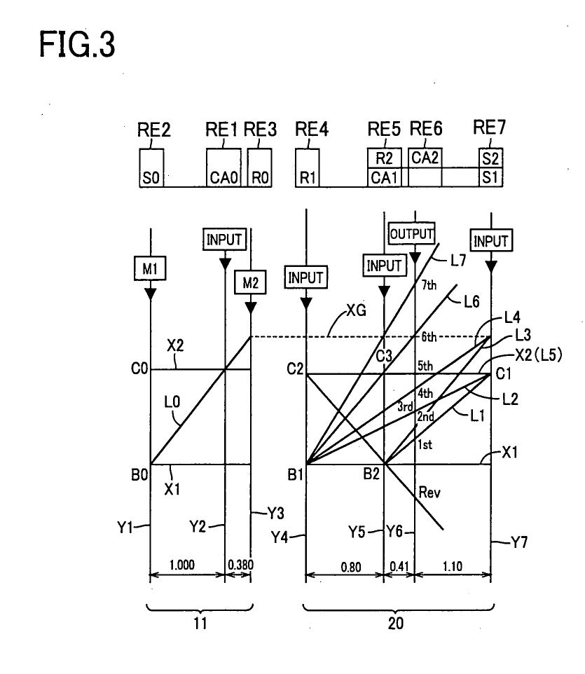

The collinear chart of FIG. 3 indicates, by straight lines, a relationship among the rotating speeds of the rotary elements in each of the gear positions of the transmission mechanism 10, which is constituted by the differential portion 11 functioning as the continuously-variable shifting portion or first shifting portion, and the automatic transmission portion 20 functioning as the step-variable shifting portion or second shifting portion. The collinear chart of FIG. 3 is a rectangular two-dimensional coordinate system in which the gear ratios ρ of the planetary gear sets 24, 26, 28 are taken along the horizontal axis, while the relative rotating speeds of the rotary elements are taken along the vertical axis. A lower one of three horizontal lines, that is, the horizontal line X1 indicates the rotating speed of 0, while an upper one of the three horizontal lines, that is, the horizontal line X2 indicates the rotating speed of 1.0, that is, an operating speed N_{E} of the engine 8 connected to the input shaft 14. The horizontal line X6 indicates the rotating speed of the power transmitting member 18.

Three vertical lines Y1, Y2 and Y3 corresponding to the power distributing mechanism 16 of the differential portion 11 respectively represent the relative rotating speeds of a second rotary element RE2 in the form of the sun gear S0, a first rotary element RE1 in the form of the carrier CA0, and a third rotary element RE3 in the form of the ring gear R0. The distances between the adjacent ones of the vertical lines Y1, Y2 and Y3 are determined by the gear ratio ρ0 of the planetary gear set 24. Further, five vertical lines Y4, Y5, Y6, Y7 and Y8 corresponding to the transmission portion 20 respectively represent the relative rotating speeds of a fourth rotary element RE4 in the form of the first ring gear R1 a fifth rotary element RE5 in the form of the first carrier CA1 and the second ring gear R2 integrally fixed to each other, a sixth rotary element RE6 in the form of the second carrier CA2, and a seventh rotary element RE7 in the form of the first and second sun gears S1, S2 integrally fixed to each other. The distances between the adjacent ones of the vertical lines are determined by the gear ratios ρ1 and ρ2 of the first and second planetary gear sets 26, 28. In the differential portion 11, the distance between the vertical lines Y1 and Y2 corresponds to “1”, while the distance between the vertical lines Y2 and Y3 corresponds to the gear ratio ρ0. In the automatic transmission portion 20, the distances between the vertical lines corresponding to the sun gear and carrier of each of the first and second planetary gear sets 26, 28 corresponds to “1”, while the distances between the vertical lines corresponding to the carrier and ring gear of the planetary gear set 26, 28 corresponds to the gear ratio ρ.

Referring to the collinear chart of FIG. 3, the power distributing mechanism 16 (differential portion 11) of the transmission mechanism 10 is arranged such that the first rotary element RE1 (carrier CA0) of the planetary gear set 24 is integrally fixed to the input shaft 14 (engine 8) and selectively connected to the second rotary element RE2 (sun gear S0) through the switching clutch C0, and this second rotary element RE2 is fixed to the first electric motor M1 and selectively fixed to the casing 12 through the switching brake B0, while the third rotary element RE3 (ring gear R0) is fixed to the power transmitting member 18 and the second electric motor M2, so that a rotary motion of the input shaft 14 is transmitted (input) to the automatic transmission portion 20 through the power transmitting member 18. A relationship between the rotating speeds of the sun gear S0 and the ring gear R0 is represented by an inclined straight line L0 which passes a point of intersection between the lines Y2 and X2.

When the transmission mechanism 10 is brought into the continuously-variable shifting state (differential state) by releasing actions of the switching clutch C0 and brake B0, for instance, the first through third rotary elements RE1-RE3 are rotatable relative to each other, for example, at least the second rotary element RE2 and the third rotary element RE3 are rotatable at respective different speeds. In this case, the rotating speed of the sun gear S0 represented by a point of intersection between the straight line L0 and the vertical line Y1 is raised or lowered by controlling the operating speed of the first electric motor M1, so that the rotating speed of the carrier CA0 represented by the straight line L0 and the vertical line Y2, that is, the engine speed N_{E} is raised or lowered, if the rotating speed of the ring gear R0 determined by the vehicle speed V and represented by a point of intersection between the straight line L0 and the vertical line Y3 is substantially held constant.

When the switching clutch C0 is engaged, the sun gear S0 and the carrier CA0 are connected to each other, and the power distributing mechanism 16 is placed in the first non-differential state in which the above-indicated three rotary elements RE1, RE2, RE3 are rotated as a unit and the second and third rotary elements RE2, RE3 are not rotatable at the respective different speeds, so that the straight line L0 is aligned with the horizontal line X2, so that the power transmitting member 18 is rotated at a speed equal to the engine speed N_{E}. When the switching brake B0 is engaged, on the other hand, the sun gear S0 is fixed to the casing 12, and the power distributing mechanism 16 is placed in the second non-differential state in which the second rotary element RE2 is stopped and the second and third rotary elements RE2, RE3 are not rotatable at the respective different speeds, so that the straight line L0 is inclined in the state indicated in FIG. 3, whereby the differential portion 11 functions as a speed increasing mechanism. Accordingly, the rotating speed of the ring gear R0 represented by a point of intersection between the straight lines L0 and Y3, that is, the rotating speed of the power transmitting member 18 is made higher than the engine speed N_{E} and transmitted to the automatic transmission portion 20.

In the automatic transmission portion 20, the fourth rotary element RE4 is selectively connected to the power transmitting member 18 through the first clutch C1, and selectively fixed to the casing 12 through the first brake B1, and the fifth rotary element RE5 is selectively connected to the power transmitting member 18 through the third clutch C3 and selectively fixed to the casing 12 through the second brake B2, while the sixth rotary element RE6 is fixed to the output shaft 22. The seventh rotary element RE7 is selectively connected to the power transmitting member 18 through the first clutch C1.

When the switching clutch C0, first clutch C1 and the second brake B2 are engaged, the automatic transmission portion 20 is placed in the first gear position. The rotating speed of the output shaft 22 in the first gear position is represented by a point of intersection between the vertical line Y6 indicative of the rotating speed of the sixth rotary element RE6 fixed to the output shaft 22 and an inclined straight line L1 which passes a point of intersection between the vertical line Y7 indicative of the rotating speed of the seventh rotary element RE7 and the horizontal line X2, and a point of intersection between the vertical line Y5 indicative of the rotating speed of the fifth rotary element RE5 and the horizontal line X1, as indicated in FIG. 3. Similarly, the rotating speed of the output shaft 22 in the second gear position established by the engaging actions of the switching brake B0, first clutch C1 and second brake B2 is represented by a point of intersection between an inclined straight line L2 determined by those engaging actions and the vertical line Y6 indicative of the rotating speed of the sixth rotary element RE6 fixed to the output shaft 22. The rotating speed of the output shaft 22 in the third gear position established by the engaging actions of the switching clutch C0, first clutch C1 and first brake B1 is represented by a point of intersection between an inclined straight line L3 determined by those engaging actions and the vertical line Y6 indicative of the rotating speed of the sixth rotary element RE6 fixed to the output shaft 22. The rotating speed of the output shaft 22 in the fourth gear position established by the engaging actions of the switching brake B0, first clutch C1 and first brake B1 is represented by a point of intersection between a straight line L4 determined by those engaging actions and the vertical line Y6 indicative of the rotating speed of the sixth rotary element RE6 fixed to the output shaft 22. The rotating speed of the output shaft 22 in the fifth gear position established by the engaging actions of the switching clutch C0, first clutch C1 and third clutch C3 is represented by a point of intersection between a horizontal line L5 and the vertical line Y6 indicative of the rotating speed of the sixth rotary element RE6 fixed to the output shaft 22. The rotating speed of the output shaft 22 in the sixth gear position established by the engaging actions of the switching clutch C0, third clutch C3 and first brake B1 is represented by a point of intersection between the vertical line Y6 determined by those engaging actions and the vertical line Y6 indicative of the rotating speed of the sixth rotary element RE6 fixed to the output shaft 22. The rotating speed of the output shaft 22 in the seventh gear position established by the engaging actions of the switching brake B0, third clutch C3 and first brake B1 is represented by a point of intersection between an inclined line L7 determined by those engaging actions and the vertical line Y6 indicative of the rotating speed of the sixth rotary element RE6 fixed to the output shaft 22. In the first, third, fifth and sixth gear positions in which the switching clutch C0 is placed in the engaged state, the fourth, fifth or seventh rotary element RE4, RE5, RE7 is rotated at the same speed as the engine speed N_{E}, with the drive force received from the differential portion 11, that is, from the power distributing mechanism 16. In the second, fourth and seventh gear positions in which the switching brake B0 is placed in the engaged state, the fifth or seventh rotary element RE5, RE7 is rotated at a speed higher than the engine speed N_{E}, with the drive force received from the differential portion 11.

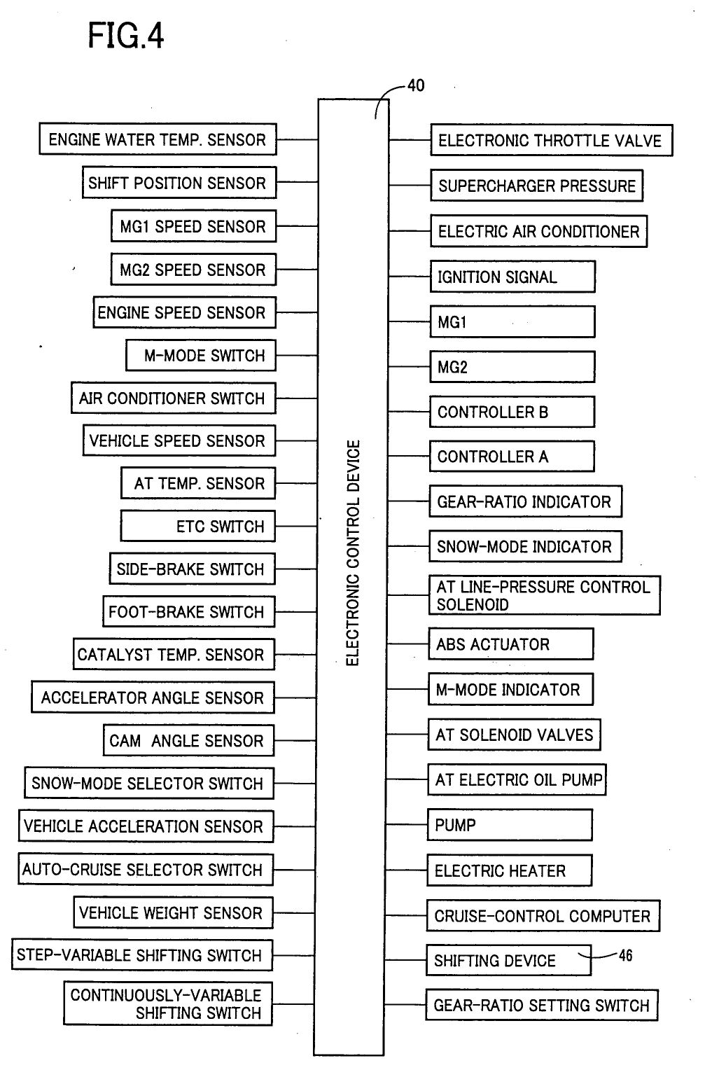

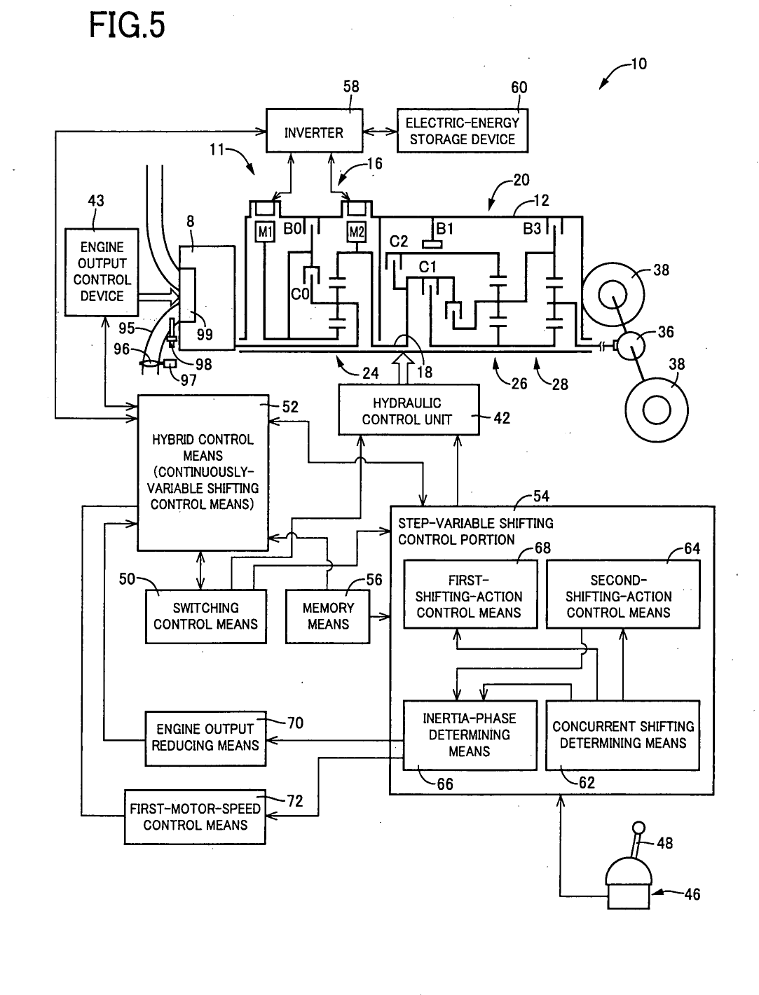

FIG. 4 illustrates signals received by an electronic control device 40 provided to control the transmission mechanism 10, and signals generated by the electronic control device 40. This electronic control device 40 includes a so-called microcomputer incorporating a CPU, a ROM, a RAM and an input/output interface, and is arranged to process the signals according to programs stored in the ROM while utilizing a temporary data storage function of the ROM, to implement hybrid drive controls of the engine 8 and electric motors M1 and M2, and drive controls such as shifting controls of the automatic transmission portion 20.

The electronic control device 40 is arranged to receive various sensors and switches shown in FIG. 4, various signals such as: a signal indicative of a temperature TEMP_{W} of cooling water of the engine 8; a signal indicative of a selected operating position P_{SH} of a shift lever 48 (FIGS. 5 and 7); a signal indicative of the operating speed N_{E} of the engine 8; a signal indicative of a value indicating a selected group of forward-drive positions of the transmission mechanism 10; a signal indicative of an M mode (manual shift drive mode); a signal indicative of an operated state of an air conditioner; a signal indicative of a vehicle speed V corresponding to the rotating speed N_{OUT} of the output shaft 22; a signal indicative of a temperature of a working oil of the automatic transmission portion 20; a signal indicative of an operated state of a side brake; a signal indicative of an operated state of a foot brake; a signal indicative of a temperature of a catalyst; a signal indicative of an amount of operation (an angle of operation) θ_{ACC} of a manually operable vehicle accelerating member in the form of an accelerator pedal (not shown); a signal indicative of an angle of a cam; a signal indicative of the selection of a snow drive mode; a signal indicative of a longitudinal acceleration value G of the vehicle; a signal indicative of the selection of an auto-cruising drive mode; a signal indicative of a weight of the vehicle; signals indicative of speeds of the drive wheels of the vehicle; a signal indicative of an operating state of a step-variable shifting switch provided to place the differential portion 11 (power distributing mechanism 16) in the step-variable shifting state (locked state) in which the transmission mechanism 10 functions as a step-variable transmission; a signal indicative of a continuously-variable shifting switch provided to place the differential portion 11 in the continuously variable-shifting state (differential state) in which the transmission mechanism 10 functions as a continuously variable transmission; a signal indicative of a rotating speed N_{M1} of the first electric motor M1 (hereinafter referred to as “first electric motor speed N_{M1}); a signal indicative of a rotating speed N_{M2} of the second electric motor M2 (hereinafter referred to as “second electric motor speed N_{M2}); and a signal indicative of an amount of electric energy SOS stored in (a charging state of) an electric-energy storage device 60 (shown in FIG. 5).

The electronic control device 40 is further arranged to generate various signals such as: control signals to be applied to an engine output control device 43 (shown in FIG. 5) to control the output of the engine 8, such as a drive signal to drive a throttle actuator 97 for controlling an angle of opening θ_{TH} of an electronic throttle valve 96 disposed in a suction pipe 95 of the engine 8, a signal to control an amount of injection of a fuel by a fuel injecting device 98 into the suction pipe 95 or cylinders of the engine 8, a signal to be applied to an ignition device 99 to control the ignition timing of the engine 8, and a signal to adjust a supercharger pressure of the engine 8; a signal to operate the electric air conditioner; signals to operate the electric motors M1 and M2; a signal to operate a shift-range indicator for indicating the selected shift position of the shift lever 48; a signal to operate a gear-ratio indicator for indicating the gear ratio; a signal to operate a snow-mode indicator for indicating the selection of the snow drive mode; a signal to operate an ABS actuator for anti-lock braking of the wheels; a signal to operate an M-mode indicator for indicating the selection of the M-mode; signals to operate solenoid-operated valves incorporated in a hydraulic control unit 42 (shown in FIG. 5) provided to control the hydraulic actuators of the hydraulically operated frictional coupling devices of the differential portion 11 and automatic transmission portion 20; a signal to operate an electric oil pump used as a hydraulic pressure source for the hydraulic control unit 42; a signal to drive an electric heater; and a signal to be applied to a cruise-control computer.

FIG. 5 is a functional block diagram of FIG. 5 for explaining major control functions of the electronic control device 40, which includes a step-variable shifting control portion 54 arranged to determine whether a shifting action of the automatic transmission portion 20 should take place, that is, to determine the gear position to which the automatic transmission portion 20 should be shifted. This determination is made on the basis of a condition of the vehicle in the form of the vehicle speed V and an output torque Tour of the automatic transmission portion 20, and according to a shifting boundary line map (shifting control map or relation) which is stored in memory means 56 and which represents shift-up boundary lines indicated by solid lines in FIG. 5 and shift-down boundary lines indicated by one-dot chain lines in FIG. 5. The step-variable shifting control portion 54 generates commands (shifting commands or hydraulic control command) to be applied to the hydraulic control unit 42, to selectively engage and release the respective two hydraulically operated frictional coupling devices (including the switching clutch C0 and brake B0), for establishing the determined gear position of the automatic transmission portion 20 according to the table of FIG. 2. Described in detail, the step-variable shifting control portion 54 commands the hydraulic control unit 42 to control the solenoid-operated valves incorporated in the hydraulic control unit 42, for activating the appropriate hydraulic actuators to concurrently engage one of the two frictional coupling device and release the other frictional coupling device, to effect the clutch-to-clutch shifting actions of the automatic transmission portion 20.

Hybrid control means 52 functions as continuously-variable shifting control means and is arranged to control the engine 8 to be operated in an operating range of high efficiency, and control the first and second electric motors M1, M2 so as to optimize a proportion of drive forces generated by the engine 8 and the second electric motor M2, and a reaction force generated by the first electric motor M1 during its operation as the electric generator, for thereby controlling the speed ratio γ0 of the differential portion 11 operating as the electrically controlled continuously variable transmission, while the transmission mechanism 10 is placed in the continuously-variable shifting state, that is, while the differential portion 11 is placed in the differential state. For instance, the hybrid control means 52 calculates a target (required) vehicle output at the present running speed V of the vehicle, on the basis of the operating amount θ_{ACC} of the accelerator pedal used as an operator's required vehicle output and the vehicle running speed V, and calculate a target total vehicle output on the basis of the calculated target vehicle output and a required amount of generation of an electric energy by the first electric motor M1. The hybrid control means 52 calculates a target output of the engine 8 to obtain the calculated target total vehicle output, while taking account of a power transmission loss, a load acting on various devices of the vehicle, an assisting torque generated by the second electric motor M2, etc. The hybrid control means 52 controls the overall speed ratio γT, the output of the engine 8 and the amount of generation of the electric energy by the first electric motor M1, so that the speed N_{E} and torque T_{E} of the engine 8 are controlled to obtain the calculated target engine output.

The hybrid control means 52 is arranged to implement the hybrid control while taking account of the presently selected gear position of the automatic transmission portion 20, so as to improve the drivability of the vehicle and the fuel economy of the engine 8. In the hybrid control, the differential portion 11 is controlled to function as the electrically controlled continuously-variable transmission, for optimum coordination of the engine speed N_{E} and vehicle speed V for efficient operation of the engine 8, and the rotating speed of the power transmitting member 18 determined by the selected gear position of the automatic transmission portion 20. That is, the hybrid control means 52 determines a target value of the overall speed ratio γT of the transmission mechanism 10, so that the engine 8 is operated according to a stored highest-fuel-economy curve (fuel-economy map or relation) stored in memory means and indicated by broken line in FIG. 7. The target value of the overall speed ratio γT of the transmission mechanism 10 permits the engine torque T_{E} and speed N_{E} to be controlled so that the engine 8 provides an output necessary for obtaining the target vehicle output (target total vehicle output or required vehicle drive force). The highest-fuel-economy curve is obtained by experimentation so as to satisfy both of the desired operating efficiency and the highest fuel economy of the engine 8, and is defined in a two-dimensional coordinate system defined by an axis of the engine speed N_{E} and an axis of the engine torque T_{E}. The hybrid control means 52 controls the speed ratio γ0 of the differential portion 11, so as to obtain the target value of the overall speed ratio γT, so that the overall speed ratio γT can be controlled within a predetermined range, for example, between 13 and 0.5.

In the hybrid control, the hybrid control means 52 controls an inverter 58 such that the electric energy generated by the first electric motor M1 is supplied to an electric-energy storage device 60 and the second electric motor M2 through the inverter 58. That is, a major portion of the drive force produced by the engine 8 is mechanically transmitted to the power transmitting member 18, while the remaining portion of the drive force is consumed by the first electric motor M1 to convert this portion into the electric energy, which is supplied through the inverter 58 to the second electric motor M2, so that the second electric motor M2 is operated with the supplied electric energy, to produce a mechanical energy to be transmitted to the output shaft 22. Thus, the drive system is provided with an electric path through which an electric energy generated by conversion of a portion of a drive force of the engine 8 is converted into a mechanical energy.

The hybrid control means 52 includes engine output control means functioning to command the engine output control device 43 for controlling the engine 8, so as to provide a required output, by controlling the throttle actuator 97 to open and close the electronic throttle valve 96, and controlling an amount and time of fuel injection by the fuel injecting device 98 into the engine 8, and/or the timing of ignition of the igniter by the ignition device 99, alone or in combination. The engine output control device 43 controls the throttle actuator 97 to open and close the electronic throttle valve 96, controls the fuel injecting device 98 to control the fuel injection, and controls the ignition device 99 to control the ignition timing of the igniter, for thereby controlling the torque of the engine 8, according to the commands received from the hybrid control means 52.

The hybrid control means 52 is capable of establishing a motor-drive mode to drive the vehicle by the electric motor, by utilizing the electric CVT function of the differential portion 11, irrespective of whether the engine 8 is in the non-operated state or in the idling state. Solid line E in FIG. 6 represents an example of a boundary line defining an engine-drive region and a motor-drive region, for switching the vehicle drive power source for starting and driving the vehicle (hereinafter referred to as “drive power source”), between the engine 8 and the electric motor (e.g., second electric motor M2). In other words, the vehicle drive mode is switchable between a so-called “engine drive mode” corresponding to the engine-drive region in which the vehicle is started and driven with the engine 8 used as the drive power source, and the so-called “motor-drive mode” corresponding to the motor-drive region in which the vehicle is driven with the second electric motor M2 used as the drive power source. A predetermined stored relationship representing the boundary line (solid line E) of FIG. 6 for switching between the engine-drive mode and the motor-drive mode is an example of a drive-power-source switching line map (drive-power-source map) in a two-dimensional coordinate system defined by control parameters in the form of the vehicle speed V and a drive-force-related value in the form of the output torque Tour. This drive-power-source switching line map is stored in the memory means 56, together with the shifting boundary line map (shifting map) indicated by solid lines and one-dot chain lines in FIG. 6.

The hybrid control means 52 determines whether the vehicle condition is in the motor-drive region or engine-drive region, and establishes the motor-drive mode or engine-drive mode. This determination is made on the basis of the vehicle condition represented by the vehicle speed V and the required output torque Tour, and according to the drive-power-source switching line map of FIG. 6. As is understood from FIG. 6, the motor-drive mode is generally established by the hybrid control means 52, when the output torque Tour is in a comparatively low range in which the engine efficiency is comparatively low, namely, when the engine torque T_{E} is in a comparatively low range, or when the vehicle speed V is in a comparatively low range, that is, when the vehicle load is comparatively low. Usually, therefore, the vehicle is started in the motor-drive mode, rather than in the engine-drive mode. When the vehicle condition upon starting of the vehicle is outside the motor-drive region defined by the drive-power-source switching line map of FIG. 6, as a result of an increase of the required output torque T_{OUT} or engine torque T_{E} due to an operation of the accelerator pedal 45, the vehicle may be started in the engine-drive mode.

For reducing a dragging of the engine 8 in its non-operated state and improving the fuel economy in the motor-drive mode, the hybrid control means 52 is arranged to hold the engine speed N_{E} at zero or substantially zero as needed, owing to the electric CVT function (differential function) of the differential portion 11, that is, by controlling the differential portion 11 to perform its electric CVT function (differential function), so that the first electric motor speed 1 is controlled so as to be freely rotated to have a negative speed N_{M1}.

The hybrid control means 52 is further capable of performing a so-called “drive-force assisting” operation (torque assisting operation) to assist the engine 8, by supplying an electric energy from the first electric motor M1 or the electric-energy storage device 60 to the second electric motor M2, so that the second electric motor M2 is operated to transmit a drive torque to the drive wheels 38. Thus, the second electric motor M2 may be used in addition to the engine 8, in the engine-drive mode. The torque assisting operation may be performed to increase the output torque of the second electric motor M2 in the motor drive mode.

The hybrid control means 52 is arranged to hold the engine speed N_{E} substantially constant or to control the engine speed N_{E} as desired, by controlling the first electric motor speed N_{M1} and/or the second electric motor speed N_{M2} owing to the electric CVT function of the differential portion 11, irrespective of whether the vehicle is stationary or running at a relatively low speed. To raise the engine speed N_{E} during running of the vehicle, for example, the hybrid control means 42 raises the first electric motor speed N_{M1} while the second electric motor speed N_{M2} determined by the vehicle speed V (rotating speed of the drive wheels 38) is held substantially constant, as is apparent from the collinear chart of FIG. 3.

The switching control means 50 is arranged to selectively switch the transmission mechanism 10 between the continuously-variable shifting state and the step-variable shifting state, that is, between the differential state and the locked state, by engaging and releasing the coupling devices (switching clutch C0 and brake B0) on the basis of the vehicle condition. For example, the switching control means 50 is arranged to determine whether the shifting state of the transmission mechanism 10 should be changed, on the basis of the vehicle condition represented by the vehicle speed V and the required output torque Tour and according to the switching boundary line map stored in the memory means 56 and indicated by two-dot chain line in FIG. 6 by way of example, namely, whether the vehicle condition is in the continuously-variable shifting region for placing the transmission mechanism 10 in the continuously-variable shifting state, or in the step-variable shifting region for placing the transmission mechanism 10 in the step-variable shifting state. The switching control means 50 places the transmission mechanism 10 in a selected one of the continuously-variable and step-variable shifting states, by engaging one or both of the switching clutch C0 and switching brake B0, depending upon whether the vehicle condition is in the continuously-variable shifting region or in the step-variable shifting region.

Described in detail, when the switching control means 50 determines that the vehicle condition is in the step-variable shifting region, the switching control means 50 disables the hybrid control means 52 to implement a hybrid control or continuously-variable shifting control, and enables the step-variable shifting control portion 54 to implement a predetermined step-variable shifting control. Further, the switching control means 50 engages the switching clutch C0 or switching brake B0 depending upon the determination by the step-variable shifting control portion 54. In the step-variable shifting control by the step-variable shifting control portion 54, the automatic transmission portion 20 is automatically shifted to one of the seven forward drive gear positions, which is selected according to the shifting boundary line map stored in the memory means 56 and indicated in FIG. 6 by way of example. FIG. 2 indicates the combinations of the engaging actions of the hydraulically operated frictional coupling devices C0, C1, C2, C3, B0, B1 and B2, which are stored in the memory means 56 and which are selectively used for automatic shifting of the automatic transmission portion 20. In the step-variable shifting state, the transmission mechanism 10 as a whole constituted by the differential portion 11 and the automatic transmission portion 20 functions as a so-called step-variable automatic transmission which is automatically shifted according to the table of FIG. 2.

When the switching control means 50 has determined that the vehicle condition is in the continuously-variable shifting region for placing the transmission mechanism 10 in the continuously-variable shifting state, the switching control means 50 commands the hydraulic control unit 42 to release both of the switching clutch C0 and brake B0, for placing the differential portion 11 in the continuously-variable shifting state. At the same time, the switching control means 50 enables the hybrid control means 52 to implement the hybrid control, and commands the step-variable shifting control portion 54 to select and hold a predetermined one of the gear positions, or to permit the automatic transmission portion 20 to be automatically shifted according to the shifting boundary line map stored in the map memory 56 and indicated in FIG. 6 by way of example. In the latter case, the variable-step shifting control portion 54 implements the automatic shifting action of the automatic transmission portion 20 to one of the four forward drive gear positions, by suitably selecting the combinations of the operating states of the frictional coupling devices indicated in the table of FIG. 2, except the combinations including the engagement of the switching clutch C0 and brake B0. Namely, the automatic transmission portion 20 is shifted to the first gear position (having the speed ratio γA of 3.683) by engaging the first clutch C1 and the second brake B2, to the second gear position (having the speed ratio γA of 1.909) by engaging the first clutch C1 and the first brake B1, to the third gear position (having the speed ratio γA of 1.000) by engaging the first clutch C1 and the third clutch C3, and to the fourth gear position (having the speed ratio γA of 0.661) by engaging the third clutch C3 and the first brake B1. Thus, the differential portion 11 switched to the continuously-variable shifting state under the control of the switching control means 50 functions as the continuously variable transmission while the automatic transmission portion 20 connected in series to the differential portion 11 functions as the step-variable transmission, so that the transmission mechanism 10 provides a sufficient vehicle drive force, such that the input speed N_{IN} of the automatic transmission portion 20 placed in one of the first through fourth gear positions, namely, the rotating speed N₁₈ of the power transmitting member 18 is continuously changed, so that the speed ratio of the transmission mechanism 10 when the transmission portion 20 is placed in one of those gear positions is continuously variable over a predetermined range. Accordingly, the speed ratio of the automatic transmission portion 20 is continuously variable across the adjacent gear positions, whereby the overall speed ratio γT of the transmission mechanism 10 is continuously variable.

The solid lines and one-dot chain lines indicated in FIG. 6 are respectively examples of the shift-up boundary lines and the shift-down boundary lines which are stored in the memory means 56 and used for determining whether the automatic transmission portion 20 should be shifted. These shift-up and shift-down boundary lines are defined in a two-dimensional coordinate system by the vehicle speed V and the drive-force-related value in the form of the required output torque T_{OUT}. The broken lines in FIG. 6 represent the upper vehicle-speed limit V1 and the upper output-torque limit T_{OUT} which are used for the switching control means 50 to determine whether the vehicle condition is in the step-variable shifting region or the continuously-variable shifting region. In other words, the broken lines represent a high-speed-running boundary line indicative of the upper vehicle-speed limit V1 above which it is determined that the hybrid vehicle is in a high-speed running state, and a high-output-running boundary line indicative of the upper output-torque limit T_{OUT1} of the output torque Tour of the automatic transmission portion 20 above which it is determined that the hybrid vehicle is in a high-output running state. The output torque Tour is an example of the drive-force-related value which relates to the drive force of the hybrid vehicle. FIG. 6 also shows two-dot chain lines which are offset with respect to the broken lines, by a suitable amount of control hysteresis for determination as to whether the step-variable shifting state is changed to the continuously-variable shifting state or vice versa. Thus, the broken lines and two-dot chain lines of FIG. 6 constitute the stored switching boundary line map (switching control map or relation) used by the switching control means 50 to determine whether the vehicle condition is in the step-variable shifting region or the continuously-variable shifting region, depending upon whether the control parameters in the form of the vehicle speed V and the output torque T_{OUT} are higher than the predetermined upper limit values V1, T_{OUT1}. This switching boundary line map may be stored in the memory means 56, together with the shifting boundary line map. The switching boundary line map may use at least one of the upper vehicle-speed limit V1 and the upper output-torque limit T_{OUT1}, or at least one of the vehicle speed V and the output torque T_{OUT}, as at least one parameter.

The above-described shifting boundary line map, switching boundary line map, and drive-power-source switching line map may be replaced by stored equations for comparison of the actual vehicle speed V with the limit value V1 and comparison of the actual output torque T_{OUT} with the limit value T_{OUT1}. In this case, the switching control means 50 determines whether the actual vehicle speed V has exceeded the upper limit V1, and switches the transmission mechanism 10 to the step-variable shifting state by engaging the switching clutch C0 or switching brake B0, when it is determined that the actual vehicle speed V has exceeded the upper limit V1. Similarly, the switching control means 50 determines whether the output torque T_{OUT} of the automatic transmission portion 20 has exceeded the upper limit T_{OUT1}, and switches the transmission mechanism 10 to the step-variable shifting state by engaging the switching clutch C0 or switching brake B0, when it is determined that the output torque Tour of the automatic transmission portion 20 has exceeded the upper limit T_{OUT1}.

The drive-force-related value indicated above is a parameter corresponding to the drive force of the vehicle, which may be the output torque T_{OUT} of the automatic transmission portion 20 taken along the vertical axis of FIG. 6 in the present embodiment, the engine output torque T_{E} or an acceleration value G of the vehicle, as well as a drive torque or drive force of drive wheels 38. The parameter may be: an actual value calculated on the basis of the operating amount θ_{ACC} of the accelerator pedal or the opening angle of the throttle valve (or intake air quantity, air/fuel ratio or amount of fuel injection) and the engine speed N_{E}; or any one of estimated values of the required (target) engine torque T_{E}, required (target) output torque T_{OUT} of the automatic transmission portion 20 and required vehicle drive force, which are calculated on the basis of the operating amount θ_{ACC} of the accelerator pedal or the operating angle θ_{TH} of the throttle valve. The above-described vehicle drive torque may be calculated on the basis of not only the output torque T_{OUT}, etc., but also the ratio of the differential gear device 36 and the radius of the drive wheels 38, or may be directly detected by a torque sensor or the like.

For instance, the upper vehicle-speed limit V1 is determined so that the transmission mechanism 10 is placed in the step-variable shifting state while the vehicle is in the high-speed running state. This determination is effective to reduce a possibility of deterioration of the fuel economy of the vehicle if the transmission mechanism 10 were placed in the continuously-variable shifting state while the vehicle is in the high-speed running state. On the other hand, the upper output-torque limit T_{OUT1} is determined depending upon the operating characteristics of the first electric motor M1, which is small-sized and the maximum electric energy output of which is made relatively small so that the reaction torque of the first electric motor M1 is not so large when the engine output is relatively high in the high-output running state of the vehicle.

The step-variable shifting region defined by the switching boundary line map of FIG. 6 is defined as a high-torque drive region in which the output torque Tour is not lower than the predetermined upper limit T_{OUT1}, or a high-speed drive region in which the vehicle speed V is not lower than the predetermined upper limit V1. Accordingly, the step-variable shifting control is implemented when the torque of the engine 8 is comparatively high or when the vehicle speed V is comparatively high, while the continuously-variable shifting control is implemented when the torque of the engine 8 is comparatively low or when the vehicle speed V is comparatively low, that is, when the engine 8 is in a normal output state.

In the present embodiment described above, the transmission mechanism 10 is placed in the continuously-variable shifting state in a low-speed or medium-speed running state of the vehicle or in a low-output or medium-output running state of the vehicle, assuring a high degree of fuel economy of the vehicle. In this case, the automatic transmission portion 20 functions as a transmission having the four gear positions, so that the maximum amount of the electric energy that should be generated by the first electric motor M1 can be reduced, whereby the required size of the first electric motor M1 can be reduced, and the required size of the vehicular drive system including the first electric motor M1 can be accordingly reduced. In a high-speed running of the vehicle at the vehicle speed V higher than the upper limit V1, or in a high-output running of the vehicle with the output torque Tour exceeding the upper limit T_{OUT1}, the transmission mechanism 10 is placed in the step-variable shifting state in which the output of the engine 8 is transmitted to the drive wheels 38 primarily through the mechanical power transmitting path, so that the fuel economy is improved owing to reduction of a loss of conversion of the mechanical energy into the electric energy, which would take place when the transmission mechanism 10 functions as the electrically controlled continuously-variable transmission.

FIG. 7 shows an example of a manually operable shifting device in the form of a shifting device 46. The shifting device 46 includes the above-described shift lever 48, which is disposed laterally adjacent to an operator's seat, for example, and which is manually operated to select one of a plurality of positions consisting of a parking position P for placing the drive system 10 (namely, automatic transmission portion 20) in a neutral state in which a power transmitting path is disconnected with both of the first and second clutches C1, C2 placed in the released state, and at the same time the output shaft 22 of the automatic transmission portion 20 is in the locked state; a reverse-drive position R for driving the vehicle in the rearward direction; a neutral position N for placing the drive system 10 in the neutral state; an automatic forward-drive shifting position D; and a manual forward-drive shifting position M.

When the shift lever 48 is operated to the automatic forward-drive shifting position D, for example, the switching control means 50 effects an automatic switching control of the transmission mechanism 10 according to the stored switching boundary line map indicated in FIG. 6, and the hybrid control means 52 effects the continuously-variable shifting control of the power distributing mechanism 16, while the step-variable shifting control portion 54 effects an automatic shifting control of the automatic transmission 20 according to the stored shifting boundary line map also indicated in FIG. 6. The automatic forward-drive position D is a position selected to establish an automatic shifting mode (automatic mode) in which the transmission mechanism 10 is automatically shifted.

When the shift lever 48 is operated to the manual forward-drive position M, on the other hand, the shifting action of the transmission mechanism 10 placed in the step-variable shifting state is automatically controlled to establish one of the gear positions the lowest speed ratio of which is determined by the manual operation of the shift lever 48 from the manual forward-drive position M, or to establish the gear position selected by the manual operation of the shift lever 48 from the manual forward-drive position M. The manual forward-drive position M is a position selected to establish a manual shifting mode (manual mode) in which the selectable gear positions of the transmission mechanism 10 are manually selected.

The transmission mechanism 10 have the seven forward drive gear positions having the speed ratios which are relatively close to each other and which change over a relatively wide range, as indicated in FIG. 2. As described above, the shifting action of the transmission mechanism 10 between the second and third gear positions and the shifting action between the fourth and fifth gear positions are effected by a shift-down action of one of the differential portion 11 and the automatic transmission portion 20, and a shift-up action of the other of the differential and automatic transmission portions 11, 20, which shift-down and shift-up actions occur concurrently. The shift-down action causes an increase of the engine speed N_{E}, while the shift-up action causes a decrease of the engine speed N_{E}, S0 that the engine speed N_{E} change in the opposite directions during the concurrent shift-down and shift-up actions of the differential portion 11 and the automatic transmission portion 20 Accordingly, the engine speed N_{E} tends to fluctuate due to even a slight difference in timing of the shift-down and shift-up actions, leading to the shifting shock of the transmission mechanism 10, which is felt uncomfortable by the occupants of the vehicle.

In view of the drawback indicated above, the step-variable shifting control portion 54 is configured to control the differential portion 11 to perform the shifting action in synchronization with the shifting action of the automatic transmission portion 20, when the shift-down action and the shift-up action of one and the other of the differential portion 11 and the automatic transmission portion 20 occur concurrently when the switching control means 50 has determined that the differential portion 11 should be switched to the step-variable shifting state. More specifically, the step-variable shifting control portion 54 is configured to control the shifting action of the differential portion such that this shifting action is initiated and terminated (completed) within an inertia phase of the shifting action of the automatic transmission portion 20.

As shown in FIG. 5, the step-variable shifting control portion 54 includes concurrent shifting determining means 62, second-shifting-action control means 64, inertia-phase determining means 66 and first-shifting-action control means 68. The concurrent shifting determining means 62 is configured to determine whether clutch-to-clutch shift-down and shift-up actions of one and the other of the differential portion 11 and the automatic transmission portion 20 should take place or occur concurrently due to a change of the vehicle condition, to shift the transmission portion 10. This determination is made on the basis of the vehicle speed V and the required output torque Tour and according to the shifting boundary line map indicated in FIG. 6 by way of example. When the concurrent shifting determining means 62 has determined that the first and second clutch-to-clutch shifting actions of the differential portion 11 and the automatic transmission portion 20 should occur concurrently, the second-shifting-action control means 64 initiates the second clutch-to-clutch shifting action of the automatic transmission portion 20 prior to the shifting action of the differential portion 11. The inertia-phase determining means 66 determines whether the second clutch-to-clutch shifting action of the automatic transmission portion 20 is in an inertia phase. The inertia-phase determining means 66 detects a moment of initiation of the inertia phase of the second clutch-to-clutch shifting action of the automatic transmission portion 20, on the basis of a change of the engine speed N_{E}. When the moment of initiation of the inertia phase of the second clutch-to-clutch shifting action of the automatic transmission portion 20 is determined by the inertia-phase determining means 66, the first-shifting-action control means 68 directly commands the hydraulic control unit 42, or commands the hydraulic control unit 42 via the switching control means 50, to initiate and terminate the first clutch-to-clutch shifting action of the differential portion 11 within the inertia phase of the second clutch-to-clutch shifting action of the automatic transmission portion 20, that is, within a period of change of the engine speed N_{E} during the shifting second action of the automatic transmission portion 20. Thus, the step-variable shifting control portion 54 is arranged to control the timings of the first shifting action of the differential portion 11 effected under the control of the first-shifting-action control means 68 and the second shifting action of the automatic transmission portion 20 effected under the control of the second-shifting-action control means 64, and to control the engaging pressures of the frictional coupling devices to be engaged to shift the transmission mechanism 10, so that the engine speed N_{E} change in only one direction (in the same direction) during the inertia phase of the second shifting action.

The electronic control device 40 further includes engine output reducing means 70 configured to be operated, upon determination of the moment of initiation of the inertia phase of the second shifting action of the automatic transmission portion 20 by the inertia-phase determining means 66, to command the engine output control means 43 via the hybrid control means 52, for temporarily reducing the output of the engine 8, within a period corresponding to the inertia phase of the shifting action of the automatic transmission portion 20, to further reduce the shifting shock of the transmission mechanism 10 due to the concurrent first and second shifting actions. The electronic control device 40 further includes first-motor-speed control means 72 also configured to be operated upon determination of the moment of initiation of the inertial phase of the second shifting action by the inertia-phase determining means 66. The first-motor-speed control means 72 functions as engine-speed control means arranged to control the speed N_{M1} of the first electric motor M1 according to a change of the input speed of the automatic transmission portion 20 (second transmission portion), that is, according to a change of the rotating speed of the power transmitting member 18, to change the engine speed N_{E} change in only one direction (in the same direction) during the inertia phase of the second shifting action, for further reducing the shifting shock of the transmission mechanism 10 due to the concurrent first and second shifting actions.

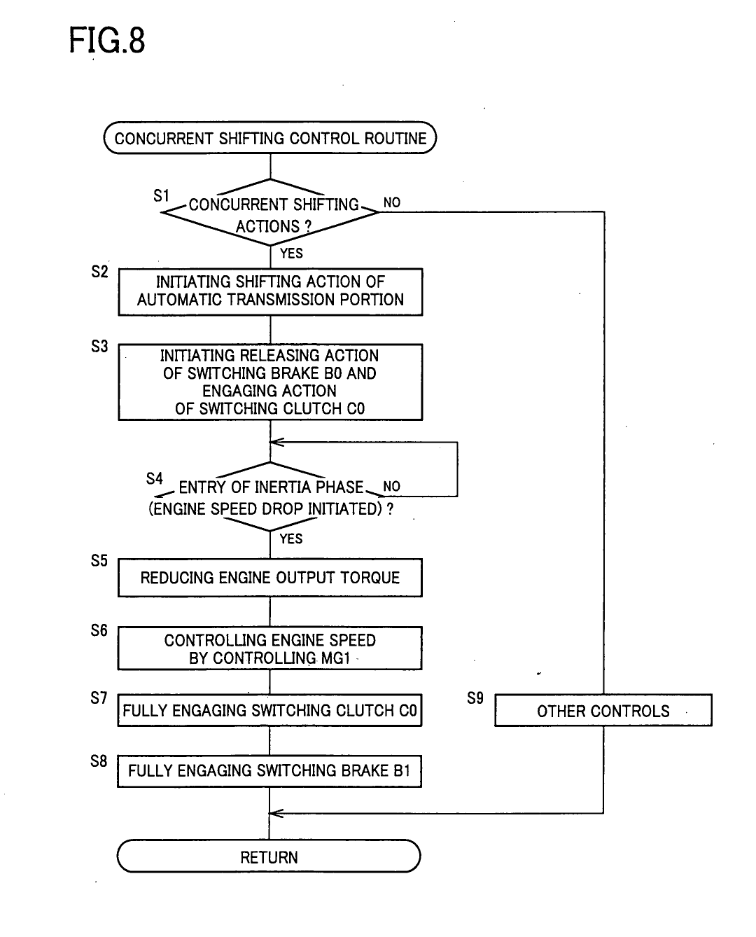

Referring next to the flow chart of FIG. 8, there will be described a concurrent shifting control routine repeatedly executed by the electronic control device 40 with a predetermined cycle time, to control the first and second shifting actions of the differential portion 11 and the automatic transmission 20 which occur substantially concurrently, in the step-variable shifting state of the transmission mechanism 10.

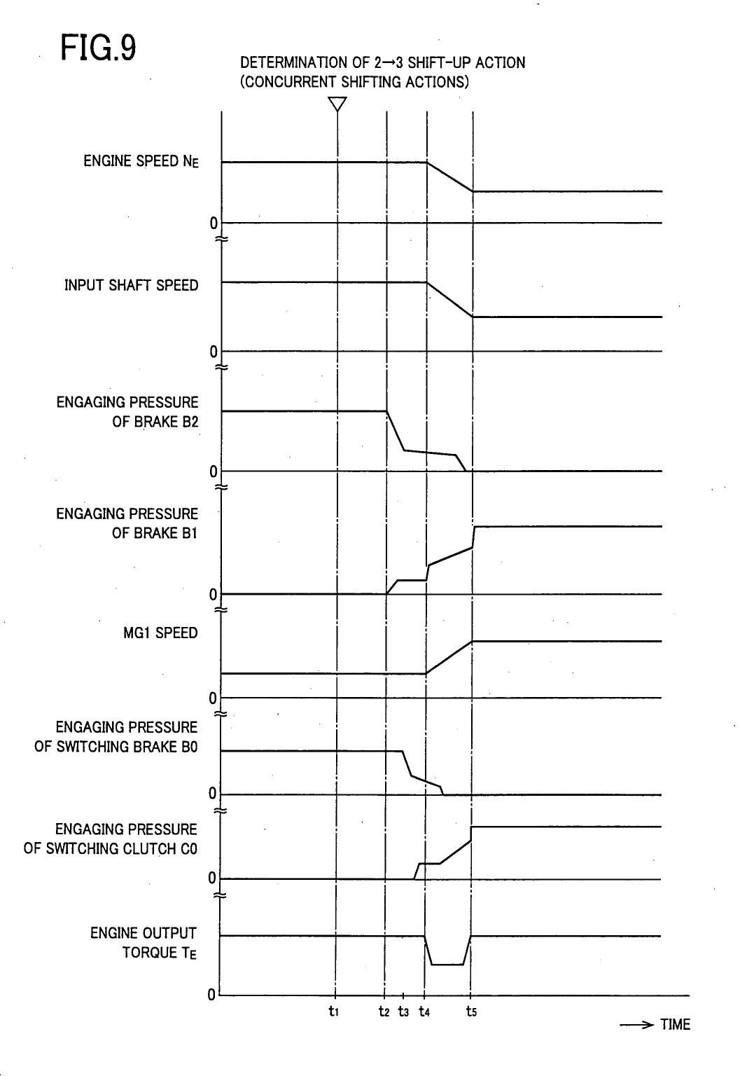

The concurrent shifting control routine is initiated with step S1 corresponding to the concurrent shifting determining means 62, to determine whether the concurrent first and second shifting actions should take place, to shift up the transmission mechanism 10 from the second gear position to the third gear position, for example. If a negative determination is obtained in step S1, the control flow goes to step S9 in which controls other than the concurrent shifting control are implemented. If an affirmative determination is obtained in step S1, at a point of time t1 indicated in the time chart of FIG. 9, the control flow goes to step S2 corresponding to the second-shifting-action control means 64, to initiate the second shifting action of the second transmission portion in the form of the automatic transmission portion 20, by initiating the releasing action of the second brake B2 and the engaging action of the first brake B1 at a point of time t2 indicated in FIG. 9. In the present example wherein the transmission mechanism 10 is shifted up from the second gear position to the third gear position, the releasing action of the second brake B2 is initiated while at the same time the engaging action of the first brake B1 is initiated, that is, a decrease of the engaging pressure of the second brake B2 is initiated while at the same time an increase of the engaging pressure of the first brake B1 is initiated. The control flow then goes to step S3 corresponding to the first-shifting-action control means 68, to initiate the releasing action of the switching brake B0 and the engaging action of the switching clutch C0, at a point of time t3 indicated in FIG. 9 prior to the moment of initiation of the inertia phase of the second clutch-to-clutch shifting action of the automatic transmission portion 20 effected by the releasing action of the second brake B2 and the engaging action of the first brake B1, so that the first clutch-to-clutch shifting action of the differential portion 11 is initiated during the inertia phase of the second clutch-to-clutch shifting action of the automatic transmission portion 20.

The control flow then goes to step S4 corresponding to the inertia-phase determining means 66, to determine or detect the moment of initiation of the inertia phase of the second shifting action of the automatic transmission portion 20, on the basis of a moment of initiation of the decrease of the engine speed N_{E} as a result of the releasing action of the second brake B2. In the example of FIG. 9, the decrease of the engine speed N_{E} is initiated at a point of time t4. Then, the control flow goes to step S5 corresponding to the engine output reducing means 70, to temporarily reduce the output of the engine 8, by reducing the opening angle of the electronic throttle valve 96 via the throttle actuator 97 or the amount of fuel injection by the fuel injecting device 98, or retarding the timing of ignition by the igniting device 99. The control flow then goes to step S6 corresponding to the first-motor-speed control means 72, to control the speed N_{M1} of the first electric motor M1 via the hybrid control means 52 according to a change of the rotating speed of the power transmitting member 18, such that the engine speed N_{E} changes in only one direction (in the same direction) at a constant rate, so that the shifting shock of the transmission mechanism 10 due to the concurrent first and second shifting actions is further reduced. In the present example wherein the transmission mechanism 10 is shifted up from the second gear position to the third gear position, a shift-up action of the automatic transmission portion 20 causes the decrease of the engine speed N_{E}, while a shift-down action of the differential portion 11 would cause an increase of the engine speed N_{E}, if step S6 was not implemented. To restrict the increase of the engine speed N_{E} and to maintain the decrease the engine speed N_{E} at a constant rate, step S6 is implemented to temporarily reduce the speed of the first electric motor M1, that is, the rotating speed of the sun gear S0, toward zero or a negative value. Then, the control flow goes to step S7 corresponding to the first-shifting-action control means 68, to increase the engaging pressure of the switching clutch C0 for fully engaging the switching clutch C0 to complete the first clutch-to-clutch shifting action (shift-down action) of the differential portion 11 during the inertia phase of the second clutch-to-clutch shifting action (shift-up action) of the automatic transmission portion 20. The control flow then goes to step S8 corresponding to the second-shifting-action control means 64, to fully engage the first brake B1 for completing the concurrent first and second shifting actions to complete the shift-up action of the transmission portion 10 from the second gear position to the third gear position, at a point of time t5 indicated in FIG. 99. The engaging timings of the clutch C0 and brake B1 and the releasing timings of the brakes B0, B2, and the pressure change rates of the clutch C0 and brakes B0, B1, B2 are controlled such that the direction of change of the engine speed N_{E} due to the second shifting action of the automatic transmission portion 20 controlled in steps S2-S8 and that of the engine speed N_{E} due to the first shifting action of the differential portion 11 controlled in steps S3-S7 coincide with each other, that is, such that the engine speed N_{E} decreases constantly during the inertia phase of the second shifting action.

As described above, the vehicular drive system control apparatus in the form of the electronic control device 40 constructed according to the present first embodiment includes the step-variable shifting control portion 54 which is provided to control the differential portion 11 (first transmission portion) operating as the step-variable transmission, upon concurrent occurrences of the shift-down action and the shift-up action of one and the other of the differential portion 11 and the automatic transmission portion 20 (second transmission portion), such that the shifting action of the differential portion 11 is performed in synchronization with the shifting action of the automatic transmission portion 20, that is, such that the shifting action of the differential portion takes 11 place during the shifting action of the automatic transmission portion 20. Accordingly, the shifting shock of the vehicular drive system can be effectively reduced, with the shift-down and shift-up actions of the differential and automatic transmission portions 11, 20 being controlled in timed relation with each other.

The step-variable shifting control portion 54 of the electronic control device 40 is further configured to control the first transmission portion operating as the step-variable transmission such that the shifting action of the first transmission portion is initiated and terminated within an inertia phase of the shifting action of the second transmission portion. Accordingly, a change of the speed of the differential portion 11 due to its shifting action is absorbed by a change of the speed of the automatic transmission portion 20 due to its shifting action, so that the shifting shock of the vehicular drive system can be effectively reduced.

The electronic control device 40 further comprises the engine output reducing means 70 configured to temporarily reduce the output torque of the engine 8 during the inertia phase of the shifting action of the automatic transmission portion 20. The arrangement permits reduction of the torque to be transmitted through the differential and automatic transmission portions 11, 20 during their shifting actions, thereby reducing the shifting shock of the transmission mechanism 10.

The electronic control device 40 includes the engine-speed control means in the form of the first-motor-speed control means 72 configured to control the differential portion 11 operating as the step-variable transmission and the automatic transmission portion 20 such that the engine speed N_{E} changes in only one direction during the shifting actions of the differential and automatic transmission portions 11, 20. In this form of the invention, the direction of change of the engine speed N_{E} caused by the shifting action of the differential portion 11 is the same as the direction of change of the engine speed N_{E} caused by the shifting action of the automatic transmission portion 20, so that the vehicle operator feels comfortable with the shifting actions of the differential and automatic transmission portions 11, 20 as if the vehicular drive system performs a single shifting action.

In the transmission mechanism 10 described above, the differential portion 11 and the automatic transmission portion 20 are disposed in the power transmitting path between the engine 8 and the drive wheels 38 of the vehicle, and the differential portion 11 includes the first electric motor M1, and the differential mechanism 16 operable to distribute the output of the engine 8 to the first electric motor M1 and the power transmitting member 18 which is the input shaft of the automatic transmission portion 20. Further, the engine-speed control means indicated above includes the first-motor-speed control means 72 configured to control the first electric motor M1 such that the engine speed N_{E} changes in the above-indicated one direction during the shifting actions of the differential and automatic transmission portions 11, 20. This arrangement permits an easy control of the first electric motor M1 such that the direction of change of the engine speed N_{E} caused by the shifting action of the differential portion 11 is the same as the direction of change of the engine speed N_{E} caused by the shifting action of the automatic transmission portion 20.

The first-motor-speed control means 72 is configured to control the operating speed N_{M1} of the first electric motor M1 according to a change of the rotating speed of the power transmitting member 18 (input shaft of the automatic transmission portion 20) during the shifting actions of the differential and automatic transmission portions 11, 20. Accordingly, the engine speed N_{E} is controlled by controlling the speed of the first electric motor M1 according to the change of the input speed of the automatic second transmission portion 20 which is initiated upon initiation of the shifting action of the automatic transmission portion 20. Thus, the engine speed N_{E} is controlled to change at a constant rate according to a progress of the shifting action of the automatic transmission portion 20.

It is also noted that the automatic transmission portion 20 includes the hydraulically operated frictional coupling devices C1-C3, B1 and B2, and that the shifting action of the automatic transmission portion 20 is the so-called “clutch-to-clutch” shifting action effected by a releasing action of one of the frictional coupling devices and an engaging action of another of the frictional coupling devices, which releasing and engaging actions take place substantially concurrently. Generally, it is difficult to control the timings of these concurrent releasing and engaging actions of the two coupling devices for performing the shifting action of the automatic transmission portion without a considerably shifting shock. However, the step-variable shifting control portion 54 of the electronic control device 40 is arranged to control the differential portion such 11 that the shifting action of the differential portion 11 is performed in synchronization with the shifting action of the automatic transmission portion 20, so as to reduce the shifting shock due to an inadequate timing control of the concurrent releasing and engaging actions of the frictional coupling devices.

The other embodiments of this invention will be described. In the following description, the same reference signs as used in the first embodiment will be used to identify the same elements, which will not be described redundantly.

### Second Embodiment

The electronic control device 40 provided according to a second embodiment of this invention is provided with a step-variable shifting control portion 73 which includes concurrent switching/shifting determining means 74, step-variable-transmission-portion control means 75, continuously-variable-transmission-portion control means 76 and switching completion determining means 78. The concurrent switching/shifting determining means 74 is configured to determine whether a switching action of the differential portion 11 between the continuously-variable and step-variable shifting state and a shifting action of the automatic transmission portion 20 should take place or occur concurrently. This determination is made on the basis of the vehicle condition represented by the vehicle speed V and the required output torque Tour, and according to the switching boundary line map and the shifting boundary line map indicated in FIG. 6 by way of example.

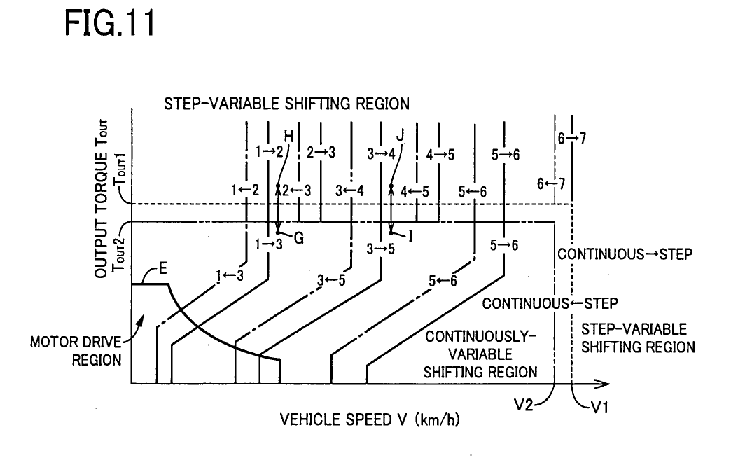

When the vehicle condition changes between points G and H, or between points I and J, as indicated in FIG. 11, for example, the continuously-variable transmission portion in the form of the differential portion 11 is switched between the continuously-variable shifting state and the step-variable shifting state, while at the same time the step-variable transmission portion in the form of the automatic transmission portion 20 is shifted between the second and third gear positions, or between the fourth and fifth gear positions. During these concurrent switching and shifting actions of the differential and automatic transmission portions 11, 20, the speed ratio γ0 of the differential portion 11 is changed due to the shifting action from the continuously-variable shifting state to the step-variable shifting state, for example, and the speed ratio γA of the automatic transmission portion 20 is changed due to the clutch-to-clutch shifting. Accordingly, the switching action of the differential portion 11 causes a decrease of the engine speed N_{E} while the shifting action of the automatic transmission portion 20 causes an increase of the engine speed N_{E}, S0 that the engine speed N_{E} may fluctuate, namely, may change in the opposite directions due to even a slight difference in timing of the switching and shifting actions, leading to the shifting shock of the transmission mechanism 10, which is felt uncomfortable by the occupants of the vehicle.

The step-variable-transmission-portion control means 75 is configured to initiate the clutch-to-clutch shifting action of the automatic transmission portion 20 prior to the switching action of the differential portion 11, when the concurrent switching/shifting determining means 74 has determined that the switching action of the differential portion 11 and the shifting action of the automatic transmission portion 20 should take place concurrently according to the switching and shifting boundary line maps and on the basis of the vehicle condition. The continuously-variable-transmission-portion control means 76 is configured to control the switching action of the differential portion 11 between the continuously-variable and step-variable shifting states such that the switching action is initiated and terminated during an inertia phase of the shifting action of the automatic transmission portion 20. The switching completion determining means 78 is configured to determine whether the switching action of the differential portion is completed. When the switching completion determining means 78 has determined that the switching action of the differential portion 11 is completed, the engine output reducing means 70 command the engine output control device 43 through the hybrid control means 52, to temporarily reduce the output torque of the engine 8, for further reducing the shifting shock of the transmission mechanism 10 due to the concurrent switching and shifting actions of the differential and automatic transmission portions 11, 20. In the present second embodiment, the first-motor-speed control means 72 is configured to control the speed N_{M1} of the first electric motor M1 through the hybrid control means, such that the direction of change of the engine speed N_{E} is not changed during the shifting action of the automatic transmission portion 20.

When the switching completion determining means 78 has determined that the switching action of the differential portion 11 is completed, the step-variable shifting control portion 73 commands the hydraulic control unit 42 to fully engage the appropriate frictional coupling device to complete the shifting action of the automatic transmission portion 20.

Upon concurrent occurrences of the switching action of the differential portion 11 from the continuously-variable shifting state to the step-variable shifting state and the shift-down action of the automatic transmission portion 20, the first-motor-speed control 72 reduces the speed N_{M1} of the first electric motor M1 toward zero, in order to maintain the direction of change of the engine speed N_{E} during the concurrent switching and shifting actions, that is, to keep an increase of the engine speed N_{E}. The reduction of the first motor speed N_{M1} toward zero makes it possible to reduce the engaging shock and load of the switching clutch C0.

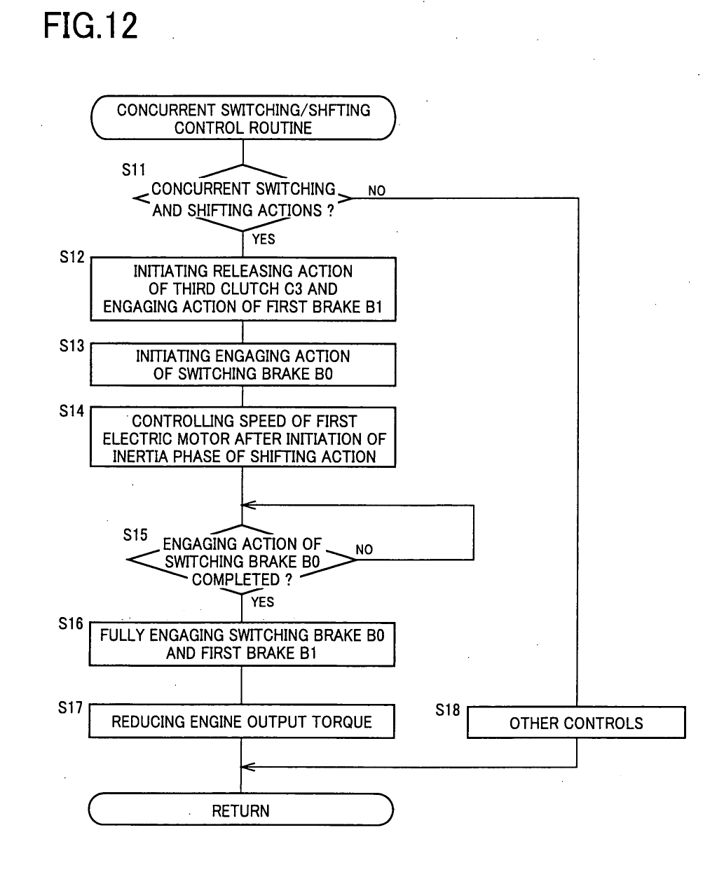

Referring next to the flow chart of FIG. 12, there will be described a concurrent switching/shifting control routine executed by the electronic control device 40 according to the present second embodiment of the invention. This control routine is repeatedly executed with a predetermined cycle time.

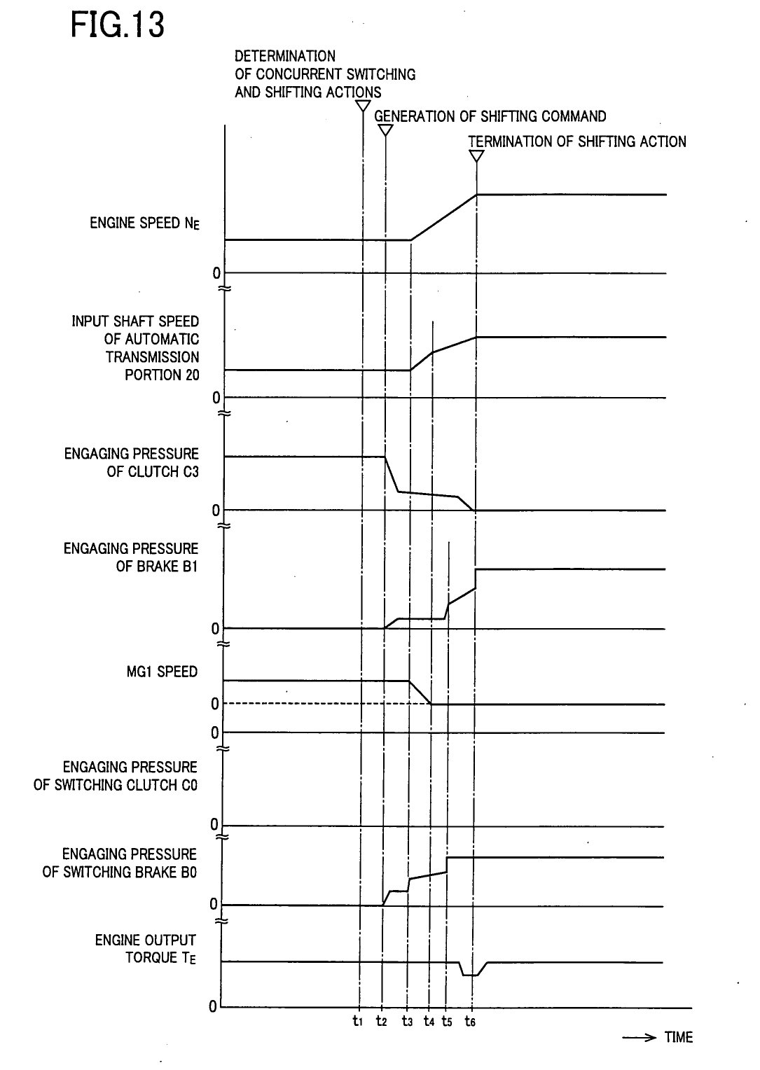

The concurrent switching/shifting control routine is initiated with step S11 corresponding to the concurrent switching/shifting determining means 74, to determine whether a switching action of the differential portion 11 and a shifting action of the automatic transmission portion 20 should occur concurrently according to the vehicle condition and on the basis of the switching and shifting boundary line maps as indicated in FIG. 11 by way of example. If a negative determination is obtained in step S11, the control flow goes to step S18 in which controls other than the concurrent switching/shifting control are implemented. If an affirmative determination is obtained in step S11, at a point of time t1 indicated in the time chart of FIG. 13, the control flow goes to step S12 corresponding to the step-variable-transmission-portion control means 75, to command the automatic transmission portion 20 (second transmission portion) to perform the shifting action in question. Where the concurrent switching and shifting actions are effected as a result of a change of the vehicle condition from the point I to the point J indicated in FIG. 11, the step-variable-transmission-portion control means 75 initiates the releasing action of the third clutch C3 and the engaging action of the first brake B1, as indicated at a point of time t2 in FIG. 13, for shifting down the automatic transmission portion 20 from the fifth gear position to the fourth gear position. That is, the change of the vehicle condition from the point I to the point J causes the shift-down action of the automatic transmission portion 20 from the fifth gear position to the fourth gear position by the releasing action of the third clutch C3 and the engaging action of the first brake B1, and concurrently causes the switching action of the differential portion 11 from the continuously-variable shifting state to the step-variable shifting state by the releasing action of the switching brake B0. In this case, the releasing action of the third clutch C3 and the engaging action of the first brake B1 are initiated at the point of time t2 indicated in FIG. 13. Then, the control flow goes to step S13 corresponding to the continuously-variable-transmission-portion control means 76, to initiate the engaging action of the switching brake B0 prior to a moment of initiation of an inertia phase of the clutch-to-clutch shift-down action of the automatic transmission portion 20, as indicated at a point of time t3 in FIG. 13, so that the switching action of the differential portion 11 to the step-variable shifting state is initiated during the inertia phase of the shift-down action of the automatic transmission portion 20.

When the moment of initiation of the inertia phase of the shift-down action of the automatic transmission 20 from the fifth gear position to the fourth gear position is detected by suitable means such as the inertia-phase determining means 66 provided in the first embodiment, the control flow goes to step S14 corresponding to the first-motor-speed control means 72, to command the hybrid control means 52 to reduce the speed N_{M1} of the first electric motor M1 toward zero according to a change of the rotating speed of the power transmitting member 18, so that the engine speed N_{E} continuously increases at a constant rate during the inertia phase, for reducing the concurrent switching/shifting shock. Namely, the shift-down action of the automatic transmission portion 20 from the fifth gear position to the fourth gear position causes an increase of the engine speed N_{E}, while at the same time the switching action of the differential portion 11 from the continuously-variable shifting state to the step-variable shifting state would cause a decrease of the engine speed N_{E}, in the absence of the first-motor-speed control means 72. In the present second embodiment, however, the speed N_{M1} of the first electric motor M1 is reduced to reduce the rotating speed of the sun gear S0 under the control of the first-motor-speed control means 72 in step S14, so that the engine speed N_{E} is continuously increased at the constant rate during the inertia phase of the shift-down action of the automatic transmission portion 20.

Step S14 is followed by step S15 corresponding to the switching completion determining means 78, to determine whether the switching action of the differential portion 11 from the continuously-variable shifting state to the step-variable shifting state is completed, that is, whether the switching brake B0 has been fully engaged. This determination is made by determining whether a ratio of the speed of the power transmitting member 18 to the speed of the input shaft 14 has reached a predetermined value (about 0.7, for example).

Step S15 is repeatedly implemented until an affirmative determination is obtained. If the affirmative determination is obtained in step S15, the control flow goes to step S16 corresponding to the continuously-variable-transmission-portion control means 76 and the step-variable-transmission-portion control means 75, to fully engage the switching brake B0 for completing the switching action of the differential portion 11 to the step-variable shifting state, and to fully engage the first brake B1 to effect the shift-down action of the automatic transmission portion 20 from the fifth gear position to the fourth gear position, as indicated at a point of time t5 in FIG. 13.

The control flow then goes to step S17 corresponding to the engine output reducing means 70, to temporarily reduce the output of the engine 8 in the engaged state of the first brake B1, as indicated at a point of time t6 in FIG. 13, by controlling the throttle actuator 97 to reduce the opening angle of the electronic throttle vale 96, reducing the amount of fuel injection by the fuel injecting device 98, or retarding the timing of ignition by the ignition device 99. The pressure change rates and engaging and releasing timings of the clutches C0, C3 and brakes B0, B1 are controlled such that the engine speed N_{E} continuously increases during the switching action of the differential portion 11 and the shifting action of the automatic transmission portion 20.

As described above, the vehicular drive system control apparatus in the form of the electronic control device 40 constructed according to the present second embodiment includes the step-variable shifting control portion 73 which is provided to control the continuously-variable transmission portion in the form of the differential portion 11, upon concurrent occurrences of the switching action of the continuously-variable transmission portion between the continuously-variable and step-variable shifting states and the shifting action of the step-variable transmission portion in the form of the automatic transmission portion 20, such that the switching action of the continuously-variable transmission portion is performed during the shifting action of the step-variable transmission portion. Accordingly, the shifting shock of the vehicular drive system can be effectively reduced, with the switching and shifting actions of the continuously-variable and step-variable transmission portions being controlled in timed relation with each other.

The step-variable shifting control portion 73 is further configured to control the differential portion 11 such that the switching action of the differential portion 11 is initiated and terminated within an inertia phase of the shifting action of the automatic transmission portion 20. In this form of the invention, a change of the speed of the differential portion 11 due to its switching action is absorbed by a change of the speed of the automatic transmission portion 20 due to its shifting action, so that the shifting shock of the vehicular drive system can be effectively reduced.

In the transmission mechanism 10 described above, the differential portion 11 and the automatic transmission portion 20 are disposed in the power transmitting path between the engine 8 and the drive wheels 38 of the vehicle, and the first-motor-speed control means 72 is provided to control the differential portion 11 and the automatic transmission portion 20 such that the engine speed N_{E} changes in the above-indicated one direction during the shifting acting of the differential portion 11. In the presence of the first-motor-speed control means 72, the direction of change of the engine speed caused by the switching action of the differential portion 11 is the same as the direction of change of the engine speed caused by the shifting action of the automatic transmission portion 20, so that the vehicle operator feels comfortable with the switching and shifting actions of the differential and automatic transmission portions 11, 20 as if the vehicular drive system performs a single shifting action.

In the transmission mechanism 10, the differential portion 11 includes the first electric motor M1, and the power distributing mechanism 16 operable to distribute the output of the engine 8 to the first electric motor M1 and the power transmitting member 18 which is the input shaft of the automatic transmission portion 20. The first-motor-speed control means 72 controls the operating speed N_{M1} of the first electric motor M1 according to a change of the rotating speed of the power transmitting member 18. Accordingly, the engine speed N_{E} can be easily controlled by controlling the operating speed N_{M1} of the first electric motor M1 according to a progress of the shifting action of the automatic transmission portion 20, such that the direction of change of the engine speed N_{E} caused by the switching action of the differential portion 11 is the same as the direction of change of the engine speed caused by the shifting action of the automatic transmission portion 20.

The electronic control device 40 of the present second embodiment further includes the engine output reducing means 70 for temporarily reducing the output torque of the engine 8 in a terminal portion of the shift-down action of the automatic transmission portion 20 which occurs concurrently with the switching action of the differential portion 20. Accordingly, the torque to be transmitted through the automatic transmission portion 20 in the terminal portion of its shift-down action is reduced, so that a speed synchronizing shock at the end of the shift-down action is reduced.

In the present second embodiment, too, the step-variable transmission portion in the form of the automatic transmission portion 20 is shifted by the releasing action of one of the plurality of frictional coupling devices C1-C3, B1, B2 and the engaging action of another of these frictional coupling devices, which releasing and engaging actions take place substantially concurrently. Since the switching action of the continuously-variable transmission is performed during the concurrent releasing and engaging actions of the two coupling devices, the switching shock of the continuously-variable transmission in the form of the differential portion 11 can be effectively reduced.

The present second embodiment is further arranged such that the speed of the first electric motor M1 is controlled by the first-motor-speed control means 72 according to a change of the rotating speed of the power transmitting member 18, that is, according to the input speed of the automatic transmission portion 20. Namely, the engine speed N_{E} is controlled by controlling the first electric motor M1 according to a change of the input speed of the automatic transmission portion 20, which change is initiated upon initiation of the shifting action. Thus, the engine speed N_{E} changes in only one direction as the shifting action progresses.

### Third Embodiment

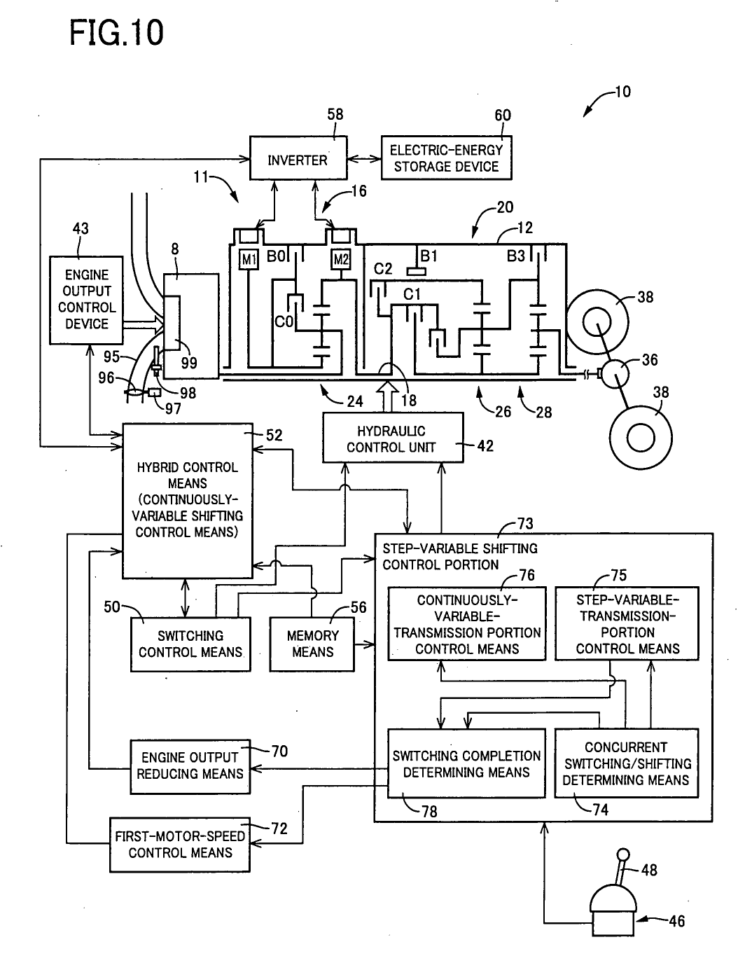

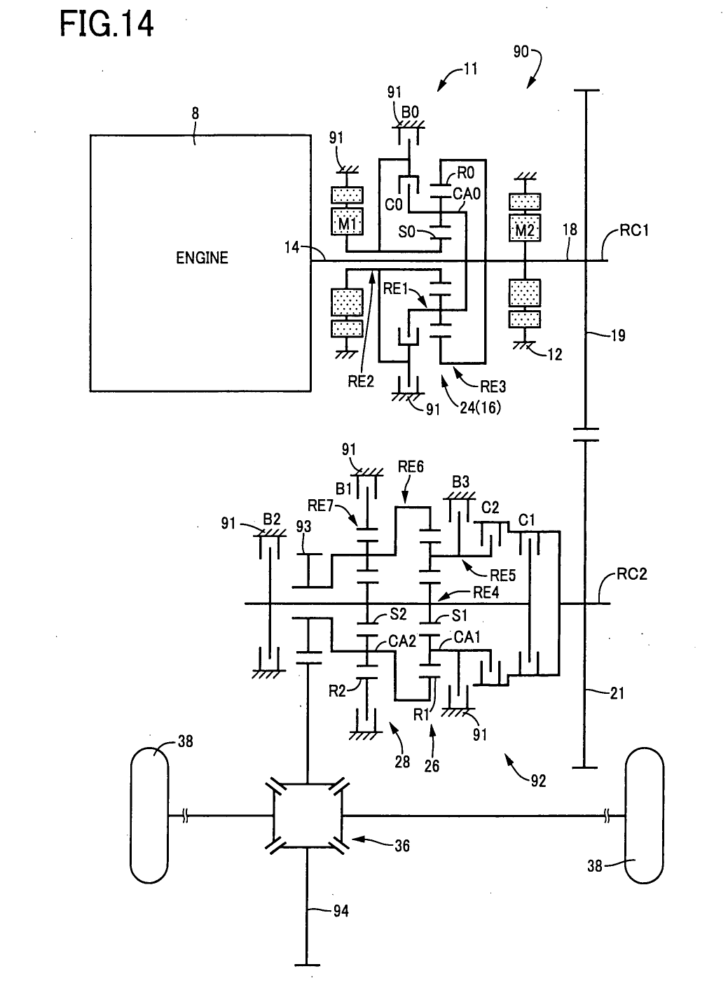

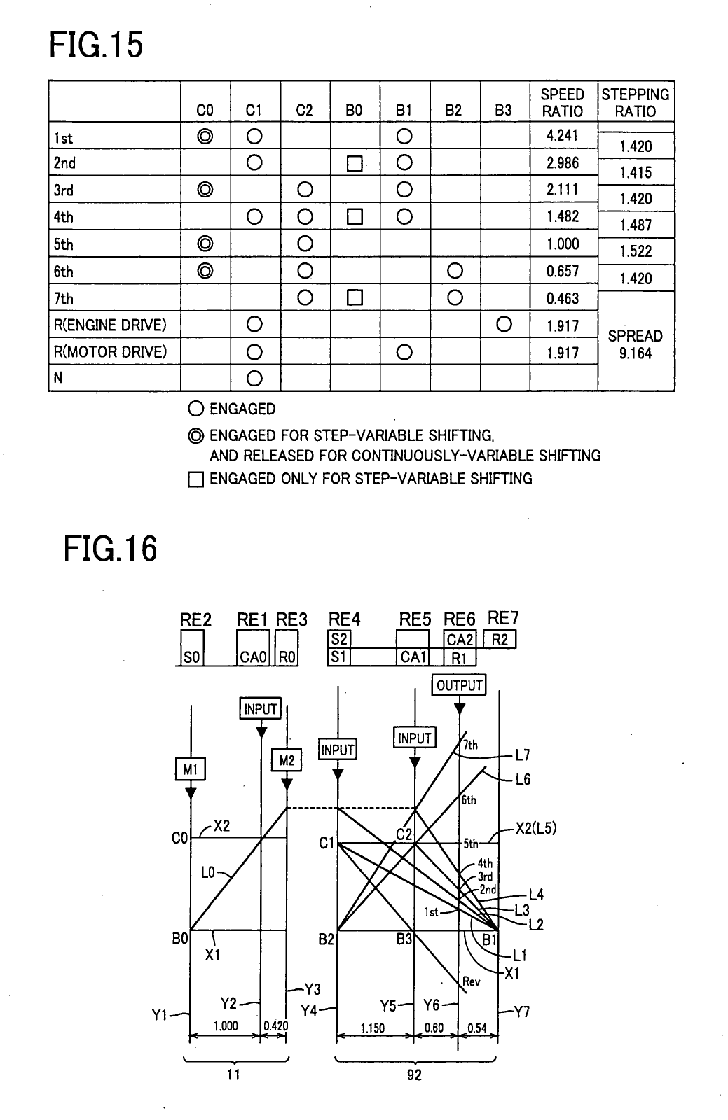

FIG. 14 is a schematic view showing an arrangement of a transmission mechanism 90 which is controllable by the electronic control device of the first embodiment of FIG. 5 or second embodiment of FIG. 10 according to a third embodiment of this invention, and FIG. 15 is a table indicating shifting actions of the transmission mechanism 90 placed in the step-variable shifting state, in relation to different combinations of the operating states of hydraulically operated frictional coupling devices to effect the respective shifting actions, while FIG. 16 is a collinear chart indicating relative rotating speeds of the transmission mechanism 90 placed in the step-variable shifting state, in different gear positions of the transmission mechanism 90.

The transmission mechanism 90 is arranged to be accommodated in a transaxle casing 91 of on an FF vehicle (front-engine front-drive vehicle), such that the differential portion 11 including the first electric motor M1, power distributing mechanism 16 and second electric motor M2 which have been described above with respect to the first embodiment is disposed on a first axis RC1, while an automatic transmission portion 92 having four forward drive gear positions is disposed on a second axis RC2 parallel to the first axis RC1. Accordingly, the axial dimension of the transmission mechanism 90 is reduced. The power distributing mechanism 16 includes the single-pinion type planetary gear set 24 having a gear ratio ρ0 of about 0.300, the switching clutch C0 and the switching brake B0. The automatic transmission portion 92 includes the first planetary gear set 26 having a gear ratio ρ1 of about 0.522, and the second planetary gear set 28 having a gear ratio ρ2 of about 0.309. The first sun gear S1 of the first planetary gear set 26 and the second sun gear S2 of the second planetary gear set 28 are integrally fixed to each other, selectively connected to the power transmitting member 18 through the first clutch C1 and mutually meshing counter drive gear 19 and counter driven gear 21, and selectively fixed to a stationary member in the form of the transaxle casing 91 through the second brake B2. The first carrier CA1 of the first planetary gear set 26 is selectively connected to the power transmitting member 18 through the second clutch C2 and the mutually meshing counter drive and driven gears 19, 21, and selectively fixed to the transaxle casing 91 through the third brake B3. The first ring gear R1 of the first planetary gear set 24 and the second carrier CA2 of the second planetary gear set 26 are integrally fixed to each other and to the output member in the form of an output gear 93, and the second ring gear R2 of the second planetary gear set 28 is selectively fixed to the transaxle casing 91 through the first brake B1. The output gear 93 meshes with a differential drive gear 94 of the differential gear device (final reduction gear device) 36, to transmit a vehicle drive force to the pair of drive wheels 38 through the pair of axles. The counter drive and driven gears 19, 21 are respectively disposed on the first and second axes C1, C2, and function as a connecting device operable to operatively connect the power transmitting member 18 to the first and second clutches C1, C2.

The transmission mechanism 90 constructed as described above is shifted to a selected one of seven forward drive gear positions (first through seventh gear positions), a reverse drive gear position and a neutral position, by an engaging action or actions of a selected one or ones of the switching clutch C0, first clutch C1, second clutch C2, switching brake B0, first brake B1, second brake B2 and third brake B3, as indicated in the table of FIG. 15. The forward drive gear positions have respective overall ratios γT (rotating speed N_{IN} of the input shaft 14/rotating speed N_{OUT} of the output gear or output member 93) which change substantially as geometrical series. The power distributing mechanism 16 is provided with the switching clutch C0 and switching brake B0, one of which is engaged to place the differential portion 11 in the fixed-speed-ration shifting state in which the differential portion 11 functions as a step-variable transmission having fixed speed ratios, and both of which are released to place the differential portion 11 in the continuously-variable shifting state in which the differential portion 11 functions as a continuously-variable transmission. The differential portion 11 placed in the fixed-speed-ratio shifting state and the automatic transmission portion 92 cooperate to constitute a step-variable transmission, while the differential portion placed in the continuously-variable shifting state and the automatic transmission portion 92 cooperate to constitute an electrically controlled continuously-variable transmission.

When the transmission mechanism 90 functions as the step-variable transmission, the transmission mechanism 90 is shifted to the first gear position having a highest speed ratio γT1 of about 4.241, by engaging actions of the switching clutch C0, first clutch C1 and first brake B1, and to the second gear position having a speed ratio γT2 of about 2.986 smaller than the speed ratio γT1, by engaging actions of the switching brake B0, first clutch C1 and first brake B1. Further, the transmission mechanism 90 is shifted to the third gear position having a speed ratio γT3 of about 2.111 smaller than the speed ratio γT2, by engaging actions of the switching clutch C0, second clutch C2 and first brake B1, and to the fourth gear position having a speed ratio of γT4 of about 1.482 smaller than the speed ratio γT3, by engaging actions of the switching brake B0, second clutch C2 and first brake B1. The transmission mechanism 90 is shifted to the fifth gear position having a speed ratio of γT5 of about 1.000 smaller than the speed ratio γT4, by engaging actions of the switching clutch C0, second clutch C2 and second brake B2, and to the sixth gear position having a speed ratio of γT6 of about 9,657 smaller than the speed ratio of γT5, by engaging actions of switching clutch C0, second clutch C2 and second brake B2, while the transmission mechanism 90 is shifted to the seventh gear position having a speed ratio γT7 of about 0.463 smaller than the speed ratio of γT6, by engaging actions of the switching brake B0, second clutch C2 and second brake B2. Further, the transmission mechanism 90 is shifted to the reverse drive gear position having a speed ratio γR of about 1.917 intermediate between the speed ratios γT3 and γT4, by engaging actions of the first clutch C1 and third brake B3 when the vehicle is driven by the engine 8, and by engaging actions of the first clutch C1 and first brake B1 when the vehicle is driven by the second electric motor M2. The transmission mechanism 90 is shifted to the neutral portion N by an engaging action of the first clutch C1 only.

When both of the switching clutch C0 and the switching brake B0 are released, the transmission mechanism 90 functions as the continuously-variable transmission. In this case, the differential portion 11 functions as a continuously-variable transmission, while the automatic transmission portion 92 connected in series to the differential portion 11 functions as a step-variable transmission having four gear positions, so that the input speed of the automatic transmission portion 92 placed in each of the first, second, third and fourth gear positions, that is, the rotating speed of the power transmitting member 18 is continuously variable over a predetermined speed ratio range. Accordingly, the overall speed ratio γT of the transmission mechanism 90 is continuously variable across the adjacent ones of the first, second, third and fourth gear positions of the automatic transmission 92.

FIG. 16 is a collinear chart indicating relative rotating speeds of the rotary elements of the transmission mechanism 90 consisting of the differential portion 11 functioning as the continuously-variable or first transmission portion and the automatic transmission portion 92 functioning as the step-variable or second transmission portion, when the transmission mechanism 90 is placed in the different gear positions which correspond to different states of connection of the rotary elements. The rotating speeds of the rotary elements of the power distributing mechanism 16 when the switching clutch C0 and brake B0 are both released and when the switching clutch C0 or switching brake B0 is engaged have been described with respect to the first embodiment.

In the collinear chart of FIG. 16, four vertical lines Y4, Y5, Y6 and Y7 correspond to the automatic transmission portion 92. The vertical line Y4 represents the fourth rotary element RE4 in the form of the first sun gear S1 and the second sun gear S2 which are fixed to each other, and the vertical line Y5 represents the fifth rotary element RE5 in the form of the first carrier CA1. The vertical line Y6 represents the sixth rotary element RE6 in the for of the second carrier CA2 and the first ring gear R1 fixed to each other, and the vertical line Y7 represents the seventh rotary element RE7 in the form of the second ring gear R1. In the automatic transmission portion 92, the fourth rotary element RE4 is selectively connected to the power transmitting member 18 through the first clutch C1, and selectively fixed to the transaxle casing 91 through the second brake B2, and the fifth rotary element RE5 is selectively connected to the power transmitting member 18 through the second clutch C2 and selectively fixed to the transaxle casing 91 through the third brake B3. The sixth rotary element RE6 is fixed to the output gear 93, and the seventh rotary element RE7 is selectively fixed to the transaxle casing 91 through the first brake B1.

When the switching clutch C0, first clutch C1 and the first brake B1 are engaged, the automatic transmission portion 92 is placed in the first gear position. The rotating speed of the output gear 93 in the first gear position is represented by a point of intersection between the vertical line Y6 indicative of the rotating speed of the sixth rotary element RE6 (R1, CA2) fixed to the output gear 93 and an inclined straight line L1 which passes a point of intersection between the vertical line Y7 indicative of the rotating speed of the seventh rotary element RE7 (R2) and the horizontal line X1, and a point of intersection between the vertical line Y4 indicative of the rotating speed of the fourth rotary element RE4 (S1, S2) and the horizontal line X2, as indicated in FIG. 16. Similarly, the rotating speed of the output gear 93 in the second gear position established by the engaging actions of the switching brake B0, first clutch C1 and first brake B1 is represented by a point of intersection between an inclined straight line L2 determined by those engaging actions and the vertical line Y6 indicative of the rotating speed of the sixth rotary element RE6 fixed to the output gear 93. The rotating speed of the output gear 93 in the third gear position established by the engaging actions of the switching clutch C0, second clutch C2 and first brake B1 is represented by a point of intersection between an inclined straight line L3 determined by those engaging actions and the vertical line Y6 indicative of the rotating speed of the sixth rotary element RE6 fixed to the output gear 93. The rotating speed of the output gear 93 in the fourth gear position established by the engaging actions of the switching brake B0, second clutch C2 and first brake B1 is represented by a point of intersection between a straight line L4 determined by those engaging actions and the vertical line Y6 indicative of the rotating speed of the sixth rotary element RE6 fixed to the output gear 93. The rotating speed of the output gear 93 in the fifth gear position established by the engaging actions of the switching clutch C0, first clutch C1 and second clutch C2 is represented by a point of intersection between a horizontal line L5 and the vertical line Y6 indicative of the rotating speed of the sixth rotary element RE6 fixed to the output gear 93. The rotating speed of the output gear 93 in the sixth gear position established by the engaging actions of the switching clutch C0, second clutch C2 and second brake B2 is represented by a point of intersection between an inclined line L6 determined by those engaging actions and the vertical line Y6 indicative of the rotating speed of the sixth rotary element RE6 fixed to the output gear 93. The rotating speed of the output gear 93 in the seventh gear position established by the engaging actions of the switching brake B0, second clutch C2 and second brake B2 is represented by a point of intersection between an inclined line L7 determined by those engaging actions and the vertical line Y6 indicative of the rotating speed of the sixth rotary element RE6 fixed to the output gear 93.

Like the transmission mechanism 10, the transmission mechanism 90 have the seven forward drive gear positions having the speed ratios which are relatively close to each other and which change over a relatively wide range, as indicated in FIG. 15. As described above, the shifting action of the transmission mechanism 90 between the second and third gear positions and the shifting action between the fourth and fifth gear positions are effected by a shift-down action of one of the differential portion 11 and the automatic transmission portion 92, and a shift-up action of the other of the differential and automatic transmission portions 11, 92, which shift-down and shift-up actions occur concurrently. The shift-down action causes an increase of the engine speed N_{E}, while the shift-up action causes a decrease of the engine speed N_{E}, S0 that the engine speed N_{E} tends to fluctuate due to even a slight difference in timing of the shift-down and shift-up actions, leading to the shifting shock of the transmission mechanism 90, which is felt uncomfortable by the occupants of the vehicle.

However, the first transmission portion in the form of the differential portion 11 is controlled such that the shifting action of the first transmission portion operating as the step-variable transmission is performed in synchronization of the shifting action of the second transmission portion in the form of the automatic transmission portion 92, when the concurrent shifting determining means 62 (FIG. 5) has determined that the shift-down action of one of the first and second transmission portions and the shift-up action of the other of the first and second transmission portions should take place concurrently.

Unlike the transmission mechanism 10 in which the power distributing mechanism 16 and the automatic transmission portion 20 are disposed on the common axis, the present transmission mechanism 90 is arranged such the power distributing mechanism 16 and the automatic transmission portion 92 are disposed on the respective two parallel axes RC1, RC2, so that the axial dimension of the transmission mechanism 90 can be reduced. Accordingly, the transmission mechanism 90 can be suitably installed transversely on an FF or FR vehicle such that the first and second axes RC1, RC2 are parallel to the lateral or transverse direction of the vehicle. In this respect, it is noted that the maximum axial direction of the transmission mechanism is limited by the lateral dimension of the FF and FR vehicles. Further, the axial dimension of the transmission mechanism 90 is further reduced, since the power distributing mechanism 16 is disposed between the engine 8 and the counter drive gear 19, while the automatic transmission portion 92 is disposed between the counter driven gear 21 and the differential drive gear 94. In addition, the axial dimension of the second axis RC2 is reduced, since the second electric motor M2 is disposed on the first axis RC1.

While the preferred embodiments of this invention have been described in detail by reference to the accompanying drawings, it is to be understood that the present invention may be otherwise embodied.

The transmission mechanisms 10, 90 are arranged such that the shifting action between the second and third gear positions, and the shifting action between the fourth and fifth gear positions are effected by a shift-down action of one of the differential portion 11 and the automatic transmission portion 20, 92 and a shift-up action of the other of the differential and automatic transmission portions 11, 20, 92, which shift-down and shift-up actions occur concurrently. However, shifting actions other than those between the second and third gear positions and between the fourth and fifth gear positions may be effected by the shift-down and shift-up actions of the differential portion 11 and the automatic transmission portions 20, 92.

Although the automatic transmission portion 20, 92 having the four forward drive gear positions functions as the second transmission portion, the automatic transmission portion 20, 92 may be replaced by an automatic transmission portion having at least two forward drive gear positions, provided a shifting action between the adjacent two forward drive gear positions is effected by a shift-down action of one of the differential portion 11 and the automatic transmission portion and a shift-up action of the other of the differential and automatic transmission portions.

In the power distributing mechanism 16 in the illustrated embodiments, the carrier CA0 is fixed to the engine 8, and the sun gear S0 is fixed to the first electric motor M1 while the ring gear R0 is fixed to the power transmitting member 18. However, this arrangement is not essential. The engine 8, first electric motor M1 and power transmitting member 18 may be fixed to any other elements selected from the three elements CA0, S0 and R0 of the first planetary gear set 24.

While the engine 8 is directly fixed to the input shaft 14 in the illustrated embodiments, the engine 8 may be operatively connected to the input shaft 14 through any suitable member such as gears and a belt, and need not be disposed coaxially with the input shaft 14. Further, the counter drive gear 19 and the counter driven gear 21 in the third embodiment of FIGS. 14-16 may be replaced by a pair of sprocket wheels and a chain connecting the sprocket wheels.

The hydraulically operated frictional coupling devices provided in the illustrated embodiments such as the switching clutch C0 and the switching brake B0 may be replaced by any other magnetic, electromagnetic and mechanical coupling devices such as magnetic power clutches, electromagnetic clutches and meshing type dog clutches.

While the second electric motor M2 is connected to the power transmitting member 18 in the illustrated embodiments, the second electric motor M2 may be connected to the output shaft 22, or a rotary member of the automatic transmission portion 20, 92.

The differential mechanism in the form of the power transmitting mechanism 16 provided in the illustrated embodiments may be replaced by a differential gear device having a pinion driven by the engine, and a pair of bevel gears which mesh with the pinion and which are operatively connected to the first electric motor M1 and the second electric motor M2.

While the power distributing mechanism 16 provided in the illustrated embodiments is constituted by one planetary gear set, the power distributing mechanism may be constituted by two or more planetary gear sets and may function as a step-variable transmission having three or more gear positions when the power distributing mechanism is placed in the non-differential state (fixed-speed-ration shifting state).

The concurrent switching and shifting actions of the differential and automatic transmission portions 11, 20 described above with respect to the second embodiment are caused by changes of the vehicle condition between the points G and H and between the points I and J indicated in FIG. 11. Namely, the vehicle condition represented by the point G corresponds to an area of the third gear position within the continuously-variable shifting region, while that represented by the point H is corresponds to an area of the second gear position within the step-variable shifting region. The vehicle condition represented by the point I corresponds to an area of the fifth gear position within the continuously-variable shifting region, while, that represented by the point J corresponds to an area of the fourth gear position within the step-variable shifting region. However, the principle of the second embodiment of this invention is equally applicable to any concurrent switching and shifting actions of the differential and automatic transmission portions 11, 20 which are caused by changes of the vehicle condition other than those indicated by the points G and H and the points I and J.

It is to be understood that the embodiments of the invention have been descried for illustrative purpose only, and that the present invention may be embodied with various changes and modifications which may occur to those skilled in the art.

1. A control apparatus for a vehicular drive system including a first transmission portion and a second transmission portion which are disposed in series with each other, the first transmission portion being operable selectively as an electrically controlled continuously-variable transmission and a step-variable transmission, and the second transmission portion having a plurality of gear positions having respective speed ratios, said control apparatus comprising:
a step-variable shifting control portion operable upon concurrent occurrences of a shift-down action of one of said first and second transmission portions and a shift-up action of the other of said first and second transmission portions, said step-variable shifting control portion being configured to control said first transmission portion operating as said step-variable transmission, such that the shifting action of said first transmission portion is performed in synchronization with the shifting action of said second transmission portion.

2. The control apparatus according to claim 1, wherein said step-variable shifting control portion controls said first transmission portion operating as said step-variable transmission such that the shifting action of the first transmission portion is initiated and terminated within an inertia phase of the shifting action of the second transmission portion.

3. The control apparatus according to claim 2, wherein the vehicular drive system further includes an engine operatively connected to said first transmission portion, said control apparatus further comprising engine output reducing means configured to temporarily reduce an output torque of said engine during the inertia phase of the shifting action of the second transmission portion.

4. The control apparatus according to claim 1, wherein the vehicular drive system further includes an engine operatively connected to said first transmission portion, said control apparatus further comprising engine-speed control means for controlling said first transmission portion operating as said step-variable transmission and said second transmission portion such that an operating speed of said engine changes in only one direction during the shifting actions of the first and second transmission portions.

5. The control apparatus according to claim 4, wherein said first and second transmission portions are disposed in a power transmitting path between said engine and drive wheels of a vehicle for which the vehicular drive system is provided, and said first transmission portion includes a first electric motor, and a differential mechanism operable to distribute an output of the engine to said first electric motor and an input shaft of said second transmission portion, said engine-speed control means including first-motor-speed control means configured to control said first electric motor such that the operating speed of the engine changes in said one direction during the shifting actions of the first and second transmission portions.

6. The control apparatus according to claim 5, wherein said first-motor-speed control means controls an operating speed of said first electric motor according to a change of a rotating speed of said input shaft of the second transmission portion during the shifting actions of the first and second transmission portions.

7. The control apparatus according to claim 5, wherein said differential mechanism includes a planetary gear set having three rotary elements that are rotatable relative to each other, and said first transmission portion includes coupling devices operable to selectively fix one of said three rotary elements to a stationary member and to selectively connect two of said three rotary elements to each other.

8. The control apparatus according to claim 1, wherein said second transmission portion includes a plurality of coupling devices, and the shifting action of the second transmission portion is effected by a releasing action of one of said plurality of coupling devices and an engaging action of another of the plurality of coupling devices, which releasing and engaging actions take place substantially concurrently.

9. The control apparatus according to claim 1, wherein the vehicular drive system includes an engine operatively connected to said first transmission portion, and the first transmission portion is a continuously-variable transmission portion which is operable as an electrically controlled continuously-variable transmission and which includes a differential mechanism operable to distribute an output of said engine to a first electric motor and a power transmitting member, and a second electric motor disposed in a power transmitting path between said power transmitting member and drive wheels of a vehicle for which the vehicular drive system is provided.

10. The control apparatus according to claim 1, wherein the vehicular drive system includes an engine operatively connected to said first transmission portion, and the first transmission portion is a differential portion including a differential mechanism operable to distribute an output of said engine to a first electric motor and a power transmitting member, and a second electric motor disposed in a power transmitting path between said power transmitting member and drive wheels of a vehicle for which the vehicular drive system is provided.

11. The control apparatus according to claim 5, wherein said differential mechanism includes a planetary gear set having three rotary elements consisting of a first rotary element connected to said engine, a second rotary element connected to said first electric motor and a third rotary element connected to said input shaft and a second electric motor.

12. The control apparatus according to claim 5, wherein said differential mechanism includes frictional coupling devices operable to place the differential mechanism in a selected one of a differential state and a non-differential state.

13. The control apparatus according to claim 12, wherein said frictional coupling devices are operable to connect selected two of rotary elements of said differential mechanism to each other for rotating the two rotary elements as a unit to give said first transmission portion a speed ratio of 1, and fix a selected one of said rotary elements to a stationary member for enabling the first transmission portion to operate as a speed-increasing device having a speed ratio smaller than 1.

14. The control apparatus according to claim 1, wherein said step-variable shifting control portion includes concurrent shifting determining means for determining whether said shift-down and shift-up actions of said one and said other of said first and second transmission portions should occur concurrently, second-shifting-action control means for initialing the shifting action of said second transmission portion when said concurrent shifting determining means has determined that the shift-down and shift-up actions should occur concurrently, inertia-phase determining means for determining whether the shifting action of said second transmission portion is in an inertia phase, and first-shifting-action control means for controlling the first transmission portion such that the shifting action of the first transmission portion is initiated and terminated within the inertia phase of the shifting action of the second transmission portion determined by the inertia-phase determining means.

15. The control apparatus according to claim 14, wherein said first-shifting-action control means controls the first transmission portion operating as said step-variable transmission, in synchronization of a shifting action of the second transmission portion from one of said plurality of gear positions to another of the gear positions.

16. The control apparatus according to claim 14, wherein said second-shifting-action control means controls said second transmission portion to perform the shifting action while a running condition of a vehicle for which the vehicular drive system is provided is in one of a high-torque running region, a high-output running region and a high-speed running region.

17. The control apparatus according to claim 1, wherein said first transmission portion includes a transmission mechanism a speed ratio of which is variable continuously or in steps.

18. A control apparatus for a vehicular device system including a continuously-variable transmission portion and a step-variable transmission portion which are disposed in series with each other, the step-variable transmission portion having a plurality of gear positions having respective speed ratios, and the continuously-variable transmission portion being switchable between a continuously-variable shifting state in which the continuously-variable transmission portion is operable as an electrically controlled continuously-variable transmission, and a step-variable shifting state in which the continuously-variable transmission portion is not operable as the electrically controlled continuously variable transmission, said control apparatus comprising:
a step-variable shifting control portion operable upon concurrent occurrences of a switching action of said continuously-variable transmission portion between said continuously-variable and step-variable shifting states and a shifting action of said step-variable transmission portion, said step-variable shifting control portion being configured to control said continuously-variable transmission portion such that the switching action of the continuously-variable transmission portion is performed during the shifting action of the step-variable transmission portion.

19. The control apparatus according to claim 18, wherein said step-variable shifting control portion controls said continuously-variable transmission portion such that the switching action of the continuously-variable transmission portion is initiated and terminated within an inertia phase of the shifting action of the step-variable transmission portion.

20. The control apparatus according to claim 19, wherein the vehicular drive system further includes an engine operatively connected to said continuously-variable transmission portion, and said continuously-variable and step-variable transmission portions are disposed in a power transmitting path between said engine and drive wheels of a vehicle for which the vehicular drive system is provided, said control apparatus further comprising engine-speed control means for controlling said continuously-variable and step-variable transmission portions such that an operating speed of said engine changes in only one direction during the shifting action of the step-variable transmission portion.

21. The control apparatus according to claim 20, wherein said continuously-variable transmission portion includes a first electric motor, and a differential mechanism operable to distribute an output of the engine to said first electric motor and an input shaft of said step-variable transmission portion, said first-motor-speed control means controlling an operating speed of said first electric motor according to a change of a rotating speed of said input shaft of the second transmission portion.

22. The control apparatus according to claim 21, wherein said differential mechanism includes a planetary gear set having a plurality of rotary elements, and said first transmission portion includes a plurality of coupling devices operable to selectively fix one of said rotary elements to a stationary member and to selectively connected two of said rotary elements to each other, said continuously-variable transmission portion being switchable between said continuously-variable and step-variable shifting states by selective engaging and releasing actions of said plurality of coupling devices.

23. The control apparatus according to claim 18, wherein the vehicular drive system further includes an engine operatively connected to said continuously-variable transmission portion, and said control apparatus further comprises engine output reducing means for temporarily reducing an output torque of said engine in a terminal portion of a shift-down action of said step-variable transmission portion which occurs concurrently with the switching action of said continuously-variable transmission portion.

24. The control apparatus according to claim 18, wherein said step-variable transmission portion includes a plurality of coupling devices, and the shifting action of the step-variable transmission portion is effected by a releasing action of one of the plurality of coupling devices and an engaging action of another of the plurality of coupling devices, which releasing and engaging actions take place substantially concurrently.

25. The control apparatus according to claim 21, wherein said differential mechanism includes a planetary gear set having three rotary elements consisting of a first rotary element connected to said engine, a second rotary element connected to said first electric motor and a third rotary element connected to said input shaft and a second electric motor.

26. The control apparatus according to claim 21, wherein said differential mechanism includes frictional coupling devices operable to place the differential mechanism in a selected one of a differential state and a non-differential state.

27. The control apparatus according to claim 26, wherein said frictional coupling devices includes a switching clutch operable to connect selected two of rotary elements of said differential mechanism to each other for rotating the two rotary elements as a unit to give said continuously-variable transmission portion a speed ratio of 1, and a switching brake operable to fix a selected one of said rotary elements to a stationary member for enabling the continuously-variable transmission portion to operate as a speed-increasing device having a speed ratio smaller than 1.

28. The control apparatus according to claim 18, wherein the vehicular drive system includes an engine operatively connected to said continuously-variable transmission portion, and said continuously-variable transmission portion includes a first electric motor, said step-variable shifting control means includes concurrent switching/shifting determining means for determining whether the switching action of said continuously-variable transmission portion and the shifting action of said step-variable transmission portion should occur concurrently, step-variable-transmission-portion control portion for initiating the shifting action of the step-variable transmission portion when said concurrent switch/shifting determining means has determined that said switching action and said shifting action should occur concurrently, continuously-variable-transmission-portion control means for controlling the switching action of the continuously-variable transmission portion such that said switching action is performed during the shifting action of the step-variable transmission portion, and switching completion determining means for determining whether said switching action is completed, said control device further comprising first-motor-speed control means for controlling an operating speed of said first electric motor such that an operating speed of said engine changes in only one direction during the shifting action of the step-variable transmission portion, and engine output reducing means for temporarily reducing an output torque of the engine after said switching completion determining means has determined that said switching is completed, said step-variable-transmission-portion control means terminating the shifting action of the step-variable transmission portion when said switching completion determining means has determined that said switching is completed.

29. The control apparatus according to claim 28, wherein said step-variable-transmission-portion control means controls said step-variable transmission portion to perform the shifting action while a running condition of a vehicle for which the vehicular drive system is provided is in one of a high-torque running region, a high-output running region and a high-speed running region.

30. The control apparatus according to claim 28, wherein said first-motor-speed control means reduces the operating speed of said first electric motor such the operating speed of said engine continuously decreases during a shift-down action of said step-variable transmission portion which occurs concurrently with the switching action of said continuously-variable transmission portion.

31. A control apparatus for a vehicular drive system including a differential portion and a step-variable transmission portion which are disposed in series with each other, the step-variable transmission portion having a plurality of gear positions having respective speed ratios, and the differential portion having a differential portion and being switchable between a differential state in which the differential mechanism is operable to perform a differential function, and a non-differential state in which the differential mechanism is not operable to perform the differential function, said control apparatus being characterized by comprising:
a step-variable shifting control portion operable upon concurrent occurrences of a switching action of said differential portion between said differential and non-differential states and a shifting action of said step-variable transmission portion, said step-variable shifting control portion being configured to control said differential portion such that the switching action of the differential portion is performed during the shifting action of the step-variable transmission portion.

32. The control apparatus according to claim 31, wherein said step-variable shifting control portion controls said differential portion such that the switching action of the differential portion is initiated and terminated within an inertia phase of the shifting action of the step-variable transmission portion.

33. The control apparatus according to claim 32, wherein the vehicular drive system further includes an engine operatively connected to said differential portion, and said differential portion and said step-variable transmission portion are disposed in a power transmitting path between said engine and drive wheels of a vehicle for which the vehicular drive system is provided, said control apparatus further comprising engine-speed control means for controlling said differential portion and said step-variable transmission portion such that an operating speed of said engine changes in only one direction during the shifting action of the step-variable transmission portion.

34. The control apparatus according to claim 33, wherein said differential portion includes a first electric motor, and said differential mechanism is operable to distribute an output of the engine to said first electric motor and an input shaft of said step-variable transmission portion, said first-motor-speed control means controlling an operating speed of said first electric motor according to a change of a rotating speed of said input shaft of the differential portion.

35. The control apparatus according to claim 31, wherein said differential mechanism includes a planetary gear set having a plurality of rotary elements, and said first transmission portion includes a plurality of coupling devices operable to selectively fix one of said rotary elements to a stationary member and to selectively connected two of said rotary elements to each other, said differential portion being switchable between said differential and non-differential states by selective engaging and releasing actions of said plurality of coupling devices.

36. The control apparatus according to claim 31, wherein the vehicular drive system further includes an engine operatively connected to said differential portion, and said control apparatus further comprises engine output reducing means for temporarily reducing an output torque of said engine in a terminal portion of a shift-down action of said step-variable transmission portion which occurs concurrently with the switching action of said differential portion.

37. The control apparatus according to claim 31, wherein said step-variable transmission portion includes a plurality of coupling devices, and the shifting action of the step-variable transmission portion is effected by a releasing action of one of the plurality of coupling devices and an engaging action of another of the plurality of coupling devices, which releasing and engaging actions take place substantially concurrently.

38. The control apparatus according to claim 31, wherein said differential mechanism includes a planetary gear set having three rotary elements consisting of a first rotary element connected to said engine, a second rotary element connected to said first electric motor and a third rotary element connected to said input shaft and a second electric motor.

39. The control apparatus according to claim 31, wherein said differential mechanism includes frictional coupling devices operable to place the differential portion in a selected one of said differential and non-differential states.

40. The control apparatus according to claim 39, wherein said frictional coupling devices includes a switching clutch operable to connect selected two of rotary elements of said differential mechanism to each other for rotating the two rotary elements as a unit to give said continuously-variable transmission portion a speed ratio of 1, and a switching brake operable to fix a selected one of said rotary elements to a stationary member for enabling the differential portion to operate as a speed-increasing device having a speed ratio smaller than 1.

41. The control apparatus according to claim 31, wherein the vehicular drive system includes an engine operatively connected to said continuously-variable transmission portion, and said differential portion includes a first electric motor, said step-variable shifting control means includes concurrent switching/shifting determining means for determining whether the switching action of said differential portion and the shifting action of said step-variable transmission portion should occur concurrently, step-variable-transmission-portion control portion for initiating the shifting action of the step-variable transmission portion when said concurrent switch/shifting determining means has determined that said switching action and said shifting action should occur concurrently, continuously-variable-transmission-portion control means for controlling the switching action of the differential portion such that said switching action is performed during the shifting action of the step-variable transmission portion, and switching completion determining means for determining whether said switching action is completed, said control device further comprising first-motor-speed control means for controlling an operating speed of said first electric motor such that an operating speed of said engine changes in only one direction during the shifting action of the step-variable transmission portion, and engine output reducing means for temporarily reducing an output torque of the engine after said switching completion determining means has determined that said switching is completed, said step-variable-transmission-portion control means terminating the shifting action of the step-variable transmission portion when said switching completion determining means has determined that said switching is completed.

42. The control apparatus according to claim 41, wherein said step-variable-transmission-portion control means controls said step-variable transmission portion to perform the shifting action while a running condition of a vehicle for which the vehicular drive system is provided is in one of a high-torque running region, a high-output running region and a high-speed running region.

43. The control apparatus according to claim 41, wherein said first-motor-speed control means reduces the operating speed of said first electric motor such the operating speed of said engine continuously decreases during a shift-down action of said step-variable transmission portion which occurs concurrently with the switching action of said differential portion.
